(19) United States
(12) Patent Application Publication
(10) Pub. No.: US 2026/0233047 A1
(43) Pub. Date: Aug. 13, 2026

(54) FIRE EXTINGUISHING FOAM COMPOSITIONS AND SYSTEMS

(71) Applicant: Chrystel WORSMAN, Parhump, NV (US)

(72) Inventor: Chrystel WORSMAN, Parhump, NV (US)

(21) Appl. No.: 18/730,758

(22) PCT Filed: Jan. 22, 2022
(86) PCT No.: PCT/US2022/013429

§ 371 Date: May 14, 2025

(51) Int. Cl. A62D 1/02; A62D 1/00

(52) U.S. Cl. CPC A62D 1/0071; A62D 1/0042

(57) ABSTRACT

Systems and foam compositions for suppressing and extinguishing several classes of fire, especially Class B, are disclosed. The composition is non fluorinated with low viscosity, superior expansion rate and a very high drainage time. The composition includes some form of powdered aloe vera, additional polysaccharides, one or more bio-surfactants, one or more thickening agents, one or more cationic ingredients, and one or more diols. The composition may also include a preservative and a pH adjusting agent.

### BACKGROUND OF THE INVENTION

### Field of the Invention

Embodiments of the invention relates generally to the field of compositions for extinguishing and suppressing fires, systems employing those compositions and their method of manufacture and use.

### Description of the Related Art

Fire extinguishing compositions are commonly employed to put out fires (e.g., extinguish them) and/or suppress the spread of fires (i.e. slow or stop their progress). Different combustible materials often are extinguished using different fire extinguishing compositions. The type of combustible material that is burning in a fire determines the classification of the fire.

In the united states, the classifications of fire include Class A (e.g., combustible materials such as wood, paper, fabric, refuse, etc.), Class B (e.g., flammable liquid and gases), Class C (e.g., electrical fires), Class D (e.g., metal fires), and Class K (e.g., cooking oils and fats).

Water-Type Fire Extinguishers contain Water and/or Water-based agents, such as Aqueous Film-Forming Foam (AFFF), Film-Forming Fluoroprotein Foam (FFFP), and Antifreeze. These fire extinguishers leave no powder residue and are effective on Class A and some Class B fires. There are two basic types of water-type fire extinguishers, Loaded Stream, and Foam.

An AFFF Foam fire extinguisher is effective on Class A and Class B fires. It can be applied to Class B liquid spills to prevent ignition. They are ideal for emergency first response vehicles. An AFFF foam is used for tackling any sudden fire as they look to starve the flames of oxygen by covering them in an effective layer of foam. The fire is then cooled as the evaporation process takes place.

An FFFP Foam fire extinguisher is effective on Class A and Class B fires. FFFP is an alcohol resistant agent making it effective on Class B fires involving alcohols, polar solvents, hydrocarbons, and combinations of these. It can be applied to Class B liquid spills to prevent ignition.

Foams are preferably used for Class B fires but can be sued for any class of fires. There are several types of foams on the market, which are developed for specific applications. However, there are currently no foam compositions in the prior art with low viscosity, very slow drain time, and high expansion ratio, that is effective on polar and non-polar solvent fires. Prior art foam formulations are characterized by high viscosities, e.g. greater than 5000 cP, which makes it necessary to change-out the proportioners in order to be able pump.

### BRIEF SUMMARY OF THE INVENTION

One or more embodiments of the invention are directed a fire extinguishing systems and foam compositions and methods of use thereof. One or more embodiments of the present invention comprises a high expansion foam formulation. Embodiments of the present invention comprise compositions that generate very thick and heavy foams, with very slow drain time, high expansion ratio, with small to medium bubbles. These compositions are effective on polar and non-polar solvent fires, especially formulated for use with the types of fires encountered in the oil industry and in military applications.

In some embodiments, the fire extinguishing composition is a concentrate. In some embodiments, the composition comprises a botanical material. In some embodiments, the composition comprises a thickening agent. In some embodiments, the composition comprises water. In some embodiments, the composition is halogen free. In some embodiments, the composition is free of sugar alcohols. In some embodiments, the composition is configured to extinguish or suppress magnesium fires. In some embodiments, the composition is configured to extinguish all classes of fires. In some embodiments, the botanical material is an aloe vera extract. In some embodiments, the thickening agent comprises a saccharide material and/or cellulosic material. In some embodiments, the thickening agent is selected from the group consisting of biopolymers constituted with simple sugar monomers, such as xanthan gum, gellan gum, guar gum, cellulose, or derivatives such as carboxymethylcellulose (CMC), methylcellulose.

In some embodiments, the composition further comprises one or more bio-based surfactants. In some embodiments, the composition further comprises a low freezing temperature agent, such as a salt or salt substitutes. In some embodiments, the composition further comprises a humectant. In some embodiments, the composition further comprises a pH adjusting agent. In some embodiments, the composition further comprises a preservative. In some embodiments, the composition further comprises one or more diols.

Some embodiments pertain to a fire extinguishing or suppressing composition comprising a botanical material. In some embodiments, the composition comprises water. In some embodiments, the composition is halogen free. In some embodiments, the composition is free of sugar alcohols. In some embodiments, the composition is free of perfluorooctanoic acid (PFOA), fluorotelomers, or perfluorooctanesulfonic acid (PFOS).

Embodiments of the present invention can include or exclude one of more of the following features.

In some embodiments, the botanical material comprises an extract from the organic inner leaf aloe vera, aloe vera extract, acemannan, or combination thereof. In some embodiments, the organic inner leaf aloe vera, aloe vera extract, acemannan or combination thereof is a powder extract that can be mixed with water to provide the botanical material. In some embodiments, the botanical material is an aloe vera extract.

In some embodiments, the composition further comprises a thickening agent. In some embodiments, the thickening agent comprises a saccharide material. In some embodiments, the saccharide comprises one or more polysaccharides. In some embodiments, the thickening agent comprises one or more of guar gum, carbomer, and/or xanthan gum. In some embodiments the thickening agent comprises a cellulosic material. In some embodiments, the thickening agent is selected from the group consisting of methylcellulose, sodium carboxymethylcellulose, cyclodextrins, polydextrose and gellan gum.

In some embodiments, the composition further comprises one or more cationic polymers. In some embodiments, the cationic polymer comprises a surfactant. In some embodiments, the cationic polymer comprises one or more derivatives of guar gum, and xanthan gum.

In some embodiments, the botanical material and the thickening agent are mutually miscible in water at a botanical material concentration of at least 0.25% and a thickening agent concentration of at least 0.3%.

In some embodiments, the composition comprises a bio-based surfactant. In some embodiments, the surfactant is coco betaine.

In some embodiments, the composition further comprises a preservative. In some embodiments, the preservative is phenoxyethanol.

In some embodiments, the composition further comprises a humectant. In some embodiments, the composition further comprises 1,3-propanediol. In some embodiments, the composition further comprises 1,2-propanediol.

In some embodiments, the composition further comprises a pH adjusting agent.

In some embodiments, the composition is configured to extinguish non-polar solvents Fires. In some embodiments, the composition is configured to extinguish non-Polar solvents fires.

Some embodiments pertain to a fire extinguishing composition comprising an acemannan polymer. In some embodiments, the composition comprises water. In some embodiments, the composition is halogen free. In some embodiments, the composition is free of sugar alcohols. In some embodiments, the composition is free of perfluorooctanoic acid (PFOA), fluorotelomers, and perfluorooctanesulfonic acid (PFOS).

In some embodiments, the composition further comprises a pH adjusting agent, in some embodiments, the pH adjusting agent is present in the range from about 0.01% to 3% by weight of the composition. In some embodiments, the pH adjusting agent comprises triethanolamine (TEA).

Some embodiments pertain to a composition concentrate comprising a botanical material. In some embodiments, the composition comprises a low freezing agent. In some embodiments, the composition comprises a thickening agent. In some embodiments, the composition comprises water. In some embodiments, the composition is halogen free. In some embodiments, the composition is free of sugar alcohols.

Some embodiments pertain to a fire extinguishing and/or a fire suppressing composition concentrate comprising aloe vera powder. In some embodiments, aloe vera powder has been reconstituted in water. Some embodiments pertain to a fire extinguishing and/or fire suppressing composition concentrate comprising aloe vera extract. In some embodiments, the composition comprises water. In some embodiments, the composition comprises a low freezing agent. In some embodiments, the composition comprises a thickening agent selected from the group consisting of guar gum, carbomer, xanthan gum, gum Arabic, pectin, acacia gum, starch, cellulose, insulin guar, karaya, agar, algin, carrageenan, furcellaran, curdlan, dextran, cellulon, pullulan, carboxymethylcellulose (CMC), methylcellulose, cyclodextrins, polydextrose, glycogen, hyaluronic acid, chitin, and combination thereof. In some embodiments, the composition comprises a bio-based surfactant, in some embodiments, the bio-based surfactant is a betaine, in some embodiments, the surfactant is a betaine amphoteric surfactant. In some embodiments, the betaine amphoteric surfactant is used as the primary surfactant. In some embodiments, the composition comprises coco betaine. In some embodiments, the composition comprises 1,3-propanediol. In some embodiments, the composition comprises Triethanolamine. In some embodiments, the composition has a pH of about 6.5 to about 7.0.

In some embodiments, the fire extinguishing composition is free of sugar alcohols. In some embodiments, the composition further comprises a preservative.

In some embodiments, the fire extinguishing composition comprises aloe vera or an aloe vera extract (e.g., a concentrated extract from an aloe vera plant). In some embodiments, the fire extinguishing composition is halogen-free. In some embodiments, the fire extinguishing composition is free of sugar alcohols. In some embodiments, the fire extinguishing composition consists of aloe vera (and/or aloe vera extract) and water.

In some embodiments, the fire extinguishing composition further comprises a low freezing temperature agent. In some embodiments, the low freezing temperature agent is present in a range from about 0.1% to 5.0% by weight of the composition. In some embodiments, the low freezing temperature agent comprises one or more of Potassium lactate, Sodium lactate, and/or potassium acetate.

In some embodiments, the fire extinguishing composition further comprises a thickening agent. In some embodiments, the thickening agent is present in a range of 0.1% to about 5.0% by weight of the composition. In some embodiments, the thickening agent comprises one or more of guar gum, carbomer, and/or xanthan gum.

In some embodiments, the fire extinguishing composition further comprises a bio-based surfactant. In some embodiments, the bio-based surfactant is amphoteric. In some embodiments, the bio-based surfactant is present in the range of about 1% to about 50% by weight of the composition. In some embodiments, the bio-based surfactant comprises one or more of coco betaine and/or sodium cocoamphoacetate, and/or glycine betaine.

In some embodiments, the fire extinguishing composition further comprises a humectant. In some embodiments, the humectant is present in a range from about 1% to about 30% by weight of the composition. In some embodiments, the humectant is 1,3-propanediol.

In some embodiments, the fire extinguishing composition further comprises a pH adjusting agent. In some embodiments, the pH adjusting agent is present in a range from about 0.01% to about 3% by weight of the composition. In some embodiments, the pH adjusting agent comprises triethylamine, triethanolamine, or both.

In some embodiments, the composition is configured to extinguish a class B fire. In some embodiments, the composition is configured to extinguish all classes of fire.

Some embodiments pertain to a fire extinguishing composition comprising acemannan and xanthan gum. In some embodiments the fire extinguishing composition is halogen free. In some embodiments, the fire extinguishing composition is free of sugar alcohols.

In some embodiments, as described elsewhere herein, the composition is prepared as a concentrate and is diluted with water to provide a diluted formulation. In some embodiments, the concentrate or dilute formulation can be used in any of the applications disclosed herein. Some embodiments pertain to a dilute fire extinguishing composition comprising any features of any embodiments described above, or described elsewhere herein, and or excluding one or more of those features. In some embodiments, the dilute composition contains the concentrate at about 3% by volume dilution with water. In some embodiments, the dilute composition contains the concentrate at about 10% by volume dilution with water.

Some embodiments pertain to a method for manufacturing a composition comprising any features of any of the embodiments described above, or described elsewhere herein, and/or excluding one or more of those features. In some embodiments, the method includes providing one or more of the ingredients of any of the embodiments described above. In some embodiments, the method includes mixing or combining any one or more ingredients of the ingredients of any of the embodiments described above. For instance, in some embodiments, a botanical ingredient is provided. In some embodiments, the botanical ingredient is mixed with water.

Some embodiments pertain to a fire extinguishing (and/or suppressing) system. In some embodiments, the system comprises a composition comprising any features of any of the embodiments described above, or described elsewhere herein, and/or excluding one or more of those features. In some embodiments, the system comprises a vessel for dispersing the composition. In some embodiments, the vessel comprises a fire extinguisher canister. In some embodiments, the vessel comprises a fire hose with a proportioner that disperses the composition into water flowing through the hose.

Compositions for extinguishing or suppressing fires, systems for using the same, methods of making compositions for extinguishing or suppressing fires, and/or methods of using the same are disclosed. The compositions can comprise a botanical material such as aloe vera or extract thereof and one or more additional chemical components/agents. The additional chemical components can include a low freeze temperature agent such as potassium lactate, a thickening/binding agent such a diol (e.g., 1,3-propanediol, 1,2-propanediol), a bio-based surfactant such as cocamidopropyl betaine, polysaccharides such as xanthan gum, guar gum or derivatives thereof, a pH adjusting agent such as triethanolamine, sodium gluconate, foaming agents, foam stabilizers, emulsifying agents, chelating agents, emollients, preservatives, bamboo extracts, algae extracts, Santalum acuminatum, Citrus glauca, wattle seed extract, cactus extract, psicose and water.

### BRIEF DESCRIPTION OF THE DRAWINGS

The above and other aspects, features and advantages of the invention will be more apparent from the following more particular description thereof, presented in conjunction with the following drawings wherein:

FIGS. 1A-C show various polysaccharides. FIG. 1A shows methylcellulose, FIG. 1B shows xanthan gum, and low acyl gellan gum in FIG. 1C, that can be used as an ingredient in one or more of the compositions disclosed herein.

FIG. 2A is a schematic of a surfactant; FIG. 2B shows spherical micelles; FIG. 2C shows formation of micelles.

FIGS. 3A-F show various bio-based surfactants that can be used as an ingredient in compositions in accordance with one or more embodiments of the present invention.

FIGS. 4A-B show the stage and results of application of an embodiment of an extinguishing foam composition on a diesel/fuel fire. FIG. 4A shows the diesel fuel after ignition; and FIG. 4B shows the final result after the fire has been extinguished in about 5 seconds.

FIGS. 5A-C show the stage and results of application of an embodiment of an extinguishing composition on a full-blown gasoline-methane mixture fuel fire; FIG. 5A shows the fuel fire at full ignition. FIG. 5B shows the fuel fire was substantially extinguished after about 30 seconds; and FIG. 5C shows the fuel fire was completely extinguished after about 60 seconds.

### DETAILED DESCRIPTION

The present invention comprising high expansion foam compositions and methods for extinguishing fire will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced items.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, 10, and ranges in between” can include 1-1, 1-3, 2-10, etc. Similarly, “1, 5, 10, 25, 50, 70, 95, or ranges including and or spanning the aforementioned values” can include 1, 5, 10, 1-5, 1-10, 10-25, 10-95, 1-70, etc.

Any portions of any of the steps, processes, structures, and or devices disclosed or illustrated in one embodiment, flowchart, or example in this disclosure can be combined or used with (or instead of) any other portion of any of the steps, processes, structures, and/or devices disclosed or illustrated in a different embodiment, flowchart, or example. The embodiments and examples described herein are not intended to be discrete and separate from each other. Combinations, variations and other implementations of the disclosed features are within the scope of this disclosure. For the methods disclosed herein, the functions performed in the processes and methods may be implemented in differing order. This disclosure of methods or uses may also include instructing the method or use (for example, in instructions for use).

In addition, where features or aspects of the disclosure are described in terms of Markush groups, those skilled in the art will recognize that the disclosure is also thereby described in terms of any individual member or subgroup members of the Markush group.

With respect to the use of substantially any plural and/or singular terms herein, those having skill in the art can translate from the plural and/or singular terms herein, those having skill in the art can translate from the plural to the singular and/or from the singular to the plural as is appropriate to the context and/or application.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more embodiments of the present invention pertain to compositions for extinguishing or suppressing fires, system for using the same, methods of making compositions for extinguishing or suppressing fires, and/or methods of using the same. In some embodiments, the compositions disclosed herein are suitable for use on Class B fires (e.g., for suppressing and/or extinguishing the fires). In some embodiments, the composition comprises one or more polysaccharides. In some embodiments, one or more of the polysaccharides comprises aloe vera or an aloe vera extract (e.g., a concentrated extract from an aloe vera plant, including an aloe vera powder).

In some embodiments, the composition comprises acemannan. In some embodiments, the fire extinguishing composition is halogen free. In some embodiments, the fire extinguishing composition is free of sugar alcohols. In some embodiments, the composition consists of aloe vera (and/or aloe vera extract) and water. In some embodiments, the fire extinguishing composition also comprises other ingredients. In some embodiments, the compositions are non-toxic. In some embodiments, the compositions are biodegradable. In some embodiments the compositions are provided as a gel or as a flowable liquid. A variety of extinguishing compositions and systems for deploying those compositions are described below to illustrate various examples that may be employed to achieve one or more desired improvements. These examples are only illustrative and are not intended in any way to restrict the general invention presented and the various aspects and features of these inventions. Furthermore, the phraseology and terminology used herein is for the purpose of description and should not be regarded as limiting. No features, structure, or step disclosed herein is essential or indispensable.

As used herein, in the context of a fire, the term “extinguish” and/or “extinguishing” shall be given its ordinary meaning and can include putting out a fire and/or causing a flame to cease to burn or shine. In some embodiments, extinguishing involves causing a material to stop smoldering.

As used herein, the term “suppress” shall be given its ordinary meaning and can include, preventing, or slowing the spread of fire, preventing or delaying ignition of fire, lowering the temperature of a fire, stopping temperature to increase of a fire, and/or causing a burning material to begin to cool.

In some embodiments, the compositions disclosed herein extinguish Class B fires (e.g. put out) and/or to suppress Class B fires (e.g. prevent or slow their spread, prevent or slow their ignition, lower their temperature, and/or stop their temperature increase).

As used herein, the term “nontoxic” or “non-toxic” shall be given its ordinary meaning and can include an agent or composition that has one or more of the following properties: it can be spread on the skin or fur of mammal without substantial skin reaction (e.g., rash, reddening, irritation, itchiness, hair loss, etc.), quantities (e.g., 10 g, 50 g, 100 g, etc.) can be ingested by mammals without substantial harm (e.g., consumption does not cause nausea, sickness, and/or harm or damage to tissues, such as the liver or kidneys).

As used herein, the term “botanical” shall be given its ordinary meaning and can include materials that are extracted, isolated, or collected from plants.

As used herein, the term “vessel” is used herein in accordance with its ordinary meaning in the art and includes any structure which is capable of holding a composition and being in fluid communication with a dispensing component. Examples may include but are not limited to, containers, such as bottles, vials, canisters, tubes, reservoirs, extinguishers canisters, etc., and materials which may hold the composition such as a sponge, cloth, gauze, etc. A dispensing component may be any feature which is capable of being in fluid communication with a vessel and dispensing a composition from the vessel to a burning area of an animal or person. Examples may include but are not limited to valves, lumens, orifices, pumps, sponges, cloths, etc. In some embodiments, an extinguishing device may comprise an absorbent material such as a sponge, cloth, gauze, etc., wherein a liquid or gel composition is absorbed therein. The absorbent material may be saturated, meaning that the material cannot absorb any more liquid, or it may contain a liquid or gel composition but not be saturated. These devices might be further packaged in a film or other sealing material to reduce evaporation or other loss of the liquid.

As used herein, the term “proportioner” is used herein in accordance with its ordinary and customary meaning, i.e., venturi devices that introduce foam concentrate into a flowing stream of water at a controlled proportioning rate. Proportioners (also known as an inductor or eductor) accurately proportion and control the mixing of pressurized foam composition concentrate into a water stream.

Some embodiments of the fire extinguishing compositions and/or methods disclosed herein solve one or more of the above issues and/or other issues not solved by conventional fire extinguishing agents. In some embodiments, the fire extinguishing and/or suppressing composition disclosed herein are non-toxic, are safe for human contact (or even ingestion), suppress or extinguish Class B fires, and/or suppress or extinguish Class A, C, D, and/or K fires. In some embodiments, the compositions suppress the heat from and/or reduce the temperature of fires generated in Class B fires. In some embodiments, the composition extinguishes Class B fires (e.g., put out) and/or to suppresses class B fires (e.g., prevent or slow their spread, prevent or spread their ignition, lower their temperature, and/or stop their temperature increase). Some embodiments pertain to systems including a composition as disclosed herein within a vessel, extinguishers, vehicle systems (e.g., in containers inside a vehicle, inside the wheel-wells, engine compartment, etc.), or in other liquid dispensers.

In some embodiments, as noted above, the fire suppressing and/or extinguishing compositions disclosed herein are formulated to extinguish Class B fires (e.g., flammables liquids and gases, polar and nonpolar, such as solvents, natural gas, etc.). In addition, the fire suppressing and/or extinguishing compositions disclosed herein may also be used to extinguish and/or suppress Class A fires (e.g., involving materials, such as wood, paper, fabric, plastic, trash, etc.), extinguish and/or suppress Class D fires (e.g., metal fires), and/or extinguish and/or suppress Class K fires (e.g., oils such as cooking oils, etc.). In some embodiments, the disclosed composition extinguishes and/or suppresses Class B, in addition to Class A, Class C, Class D and Class K fires simultaneously.

In some embodiments, once a fire is extinguished using a composition as disclosed herein, the previously burning material (e.g., the extinguished material) rapidly cools. In some embodiments, after extinguishing, the previously burning material is almost instantly or substantially instantly cool to the touch. In some embodiments, after extinguishing, the extinguished material is cool to the touch. (e.g., by hand or by a body part) within equal to less than about 1 second(s), 5 s, 10 s, 30 s, or ranges including and/or spanning the aforementioned values. In some embodiments, after extinguishing, the extinguished material reaches temperature less than about room temperature (less than about 74° F.) within equal to less than 1 s, 5 s, 10 s, 30 s, 1 minute, 5 minutes, or ranges including and/or spanning the aforementioned values. In some embodiments, after extinguishing, the extinguished material reaches a temperature less than about 150° F. (and/or a temperature that is safe to the touch with skin) within equal to less than about: 1 s, 5 s, 10 s, 30 s, 1 minute, 5 minutes, or ranges including and/or spanning the aforementioned values.

In some embodiments, the fire suppressing and/or extinguishing composition comprises a temperature suppressing agent and/or a water delivery agent. In some embodiments, the temperature suppressing agent can act as water delivery agent preventing and/or inhibiting the evaporation of water so that it can be delivered to the burning material. In some embodiments, the temperature suppressing agent delivers foam to a fire (e.g., a Class B fire) and simultaneously prevents the fuel from further fueling the fire. In some embodiments, the temperature suppressing agent delivers water that has been added to the temperature suppressing agent during preparation of the fire suppressing and/or extinguishing composition and/or water that is residual in the suppressing agent (e.g., water that is not added to the temperature suppressing agent). In some embodiments, the temperature suppressing agent has no water added.

In some embodiments, the fire suppressing and/or fire extinguishing composition is prepared as a concentrate (e.g., a concentrated solution and/or a concentrated mixture). In some embodiments, the concentrate is a gel (e.g., a flowable gel, a hydrogel, a thixotropic gel, etc.). In some embodiments, the concentrate comprises water. In some embodiments, the fire suppressing and/or extinguishing composition is prepared by diluting a concentrate with water to form a wetting composition. For example, in some embodiments, a concentrate, (which may already comprise some water) is diluted prior to use in, for example, a fire extinguisher, (or other device for deploying the fire extinguishing agent). In some embodiments, the concentrate is used without dilution to extinguish and/or suppress fire. In other words, in some embodiments, the fire suppressing and/or extinguishing composition is the concentrate. In some embodiments, the composition has a viscosity of equal to or less than about 10000 cP, 5000 cP, 1000 cP, 500 cP, 5 cP, or ranges including and/or spanning the aforementioned values.

Some embodiments comprise a temperature suppressing agent and/or water delivery agent. In some embodiments, it is believed that the temperature suppressing agent and/or extinguishing composition acts as a water delivery agent. In some embodiments, as disclosed elsewhere herein, the temperature suppressing agent comprises an organic polymeric material. In some embodiments, as disclosed elsewhere herein, the temperature suppressing agent comprises and/or consists of a botanical material. In some embodiments, the botanical ingredient is a gel (e.g., a botanical gel, etc.). In some embodiments, the botanical material is aloe vera and/or an extract of aloe vera. Without being bound to a particular mechanism, it is believed that the botanical material (e.g., aloe vera and/or aloe vera extract thereof), and mainly the acetylated mannose-rich polymer (acemannan) that functions as storage polysaccharides acts as a temperature reducing agent and/or water delivering material in the fire suppressing and/or extinguishing composition. In some embodiments, the botanical material is powdered and/or concentrated. In some embodiments, powdered botanical materials can be reconstituted (e.g., mixed with a diluent such as water) prior to its use in the composition.

In some embodiments, the weight percent of botanical material (e.g., aloe vera, aloe vera extract, reconstituted aloe vera, etc.) in the fire suppression and/or extinguishing composition concentrate is equal to or at least about: 0.5%, 1%, 5%, 10%, 25%, 50%, 70%, 95%, or ranges including and/or spanning the aforementioned values. In some embodiments, the weight percent of botanical material (e.g., aloe vera, aloe vera extract, reconstituted aloe vera extract, etc.) in the fire suppressing and/or extinguishing compositions concentrate is equal to or less than about: 0.5%, 1%, 5%, 10%, 25%, 50%, 70%, 75%, 80%, 85%, 95%, or ranges including and/or spanning the aforementioned values. In some embodiments, the concentrated fire suppressing and/or extinguishing composition consists of aloe vera or an extract of aloe vera and/or water.

In some embodiments, as disclosed elsewhere herein, a composition concentrate is prepared which can be diluted prior to use. In some embodiments, the weight percent of botanical (e.g., aloe vera, aloe vera extract, reconstituted aloe vera extract, etc.) in the fire suppressing and/or extinguishing composition, after dilution (e.g., with water) is equal to or at least about: 0.1%, 0.2%, 0.5%, 1.0%, 2.5%, 5.0%, 7.0%, 9.5%, or ranges including and/or spanning the aforementioned values. In some embodiments, the weight percent of botanical material (e.g., aloe vera, aloe vera extract, reconstituted aloe vera extract, etc.) in the fire suppressing and/or extinguishing composition after dilution (e.g., with water) is equal to or less than about: 0.1%, 0.2%, 0.5%, 1.0%, 2.5%, 5.0%, 7.0%, 9.5%, or ranges including and/or spanning the aforementioned values.

In some embodiments, instead of or in addition to the botanical material, the composition comprises a saccharide material. In some embodiments, the saccharide material can be used as a thickening agent, as an emulsion stabilizer agent, as a temperature suppressing agent, as a microencapsulation agent, and/or as a water delivery agent. In some embodiments, the saccharide material is a polysaccharide. In some embodiments, the botanical material comprises a polysaccharide and/or is a polysaccharide (e.g., a hydrogel or reconstituted polysaccharide). In some embodiments, the polysaccharide is hydrophilic. In some embodiments, the polysaccharide is amphiphilic. In some embodiments, the polysaccharide is cross linkable (e.g., through ionic bonding with, for example, calcium or covalent bonding with for example, multifunctional crosslinking agents). In some embodiments, the polysaccharide is a natural polysaccharide. In some embodiments, the polysaccharide is a synthetic polysaccharide.

In some embodiments, the polysaccharide is selected from one or more of acemannan, alginate, chitosan, cellulose, callose, laminarin, chrysolaminarin, xylan, arabinoxylan, mannan, fucoidan, galactomannan, galactoarabinan, hydroxypropyl cellulose, and/or hydroxymethyl cellulose. In some embodiments, the polysaccharide is selected from one or more of a cellulose, a cellulose derivative, insulin guar, karats, pectin, agar, algin, carrageenan, furcellaran, gellan, curdlan, dextran, cellulon, pullulan, carboxymethylcellulose (e.g., the free acid sodium salt, potassium salt, etc.), methylcellulose, cyclodextrins, polydextrose, glycogen, hyaluronic acid (HA), and/or chitin. In some embodiments, the polysaccharide is acemannan.

In some embodiments, the polysaccharide is selected based on properties that reduces emulsion particle size to enhance emulsion uniformity and promote stability, while adding minimal contribution to the viscosity of the formulation. The selected polysaccharide should also provide minimal interference with the formulation's pH, salt content, ionic species, as well as shear, while also being environmentally friendly and readily biodegradable.

In some embodiments, the polysaccharide comprises a cellulosic material. In some embodiments, the cellulosic material is one or more of methylcellulose, carboxy methylcellulose (including salt thereof such as sodium carboxymethylcellulose), gellan gum, hydroxyethyl cellulose, hydroxypropyl methylcellulose, ethyl cellulose, and/or a hydrolyzed cellulose.

It has been noted that by adding botanical material(s) and/or polysaccharides to the fire suppressing and/or extinguishing composition, a cooling effect occurs, when a fire is extinguished or suppressed. Without being bound to a particular mechanism, it is believed that the botanical material (e.g., aloe vera plant extract, a botanical gel or extract) enhances the heat capacity of the suppressing and/or extinguishing composition and removes heat from the fire. It is also noted that the complex matrix formed by the addition of botanical materials and/or polysaccharides to certain bio-surfactants, enhances the emulsion stability of the suppressing and/or extinguishing composition and, hence, encapsulates the fuel. In some embodiments, it is believed that the addition of a botanical and/or polysaccharide helps prevent re-ignition by encapsulating and/or cooling the fuel source.

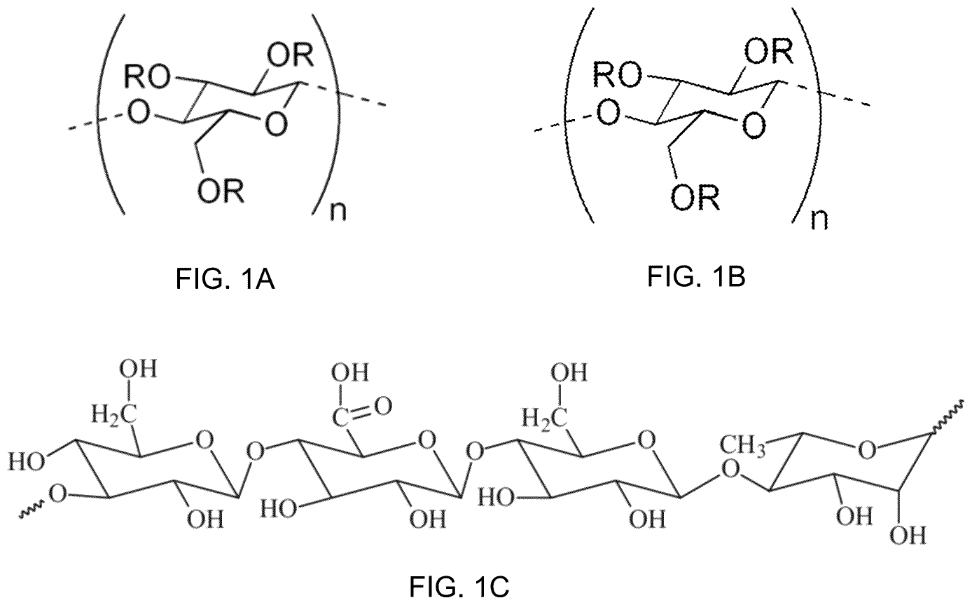

In some embodiments, saccharides are used as thickeners. In some embodiments, the saccharides are celluloses. In some embodiments, the celluloses are synthetic. Without being bound to any particular theory, it was proposed that, with a simpler structure off the cellulose backbone, higher miscibility could be achieved along with good thermal stability using one or more of methylcellulose, carboxymethylcellulose (e.g., the sodium salt or potassium salt), and/or gellan gum. Three derivatives selected for testing were methylcellulose (FIG. 1A (where R═H or CH₃). Series H; properties: hydrophilic, soluble in cold water (may precipitate at 40° C. or higher, can act as a thickener and/or and emulsifier), sodium carboxymethylcellulose (FIG. 1B (where R═H or CH₂CO₂H); Series I; properties: hydrophilic, readily soluble in hot and cold water; good compatibility with glycols and other cellulose derivatives, anionic), and low acyl gellan gum (FIG. 1C; Series J; Properties: readily soluble in water, holds particles in suspension well without significantly increasing viscosity, part of class of hydrogels with good heat resistance). All of these celluloses were chosen because they have favorable properties for the tests being considered.

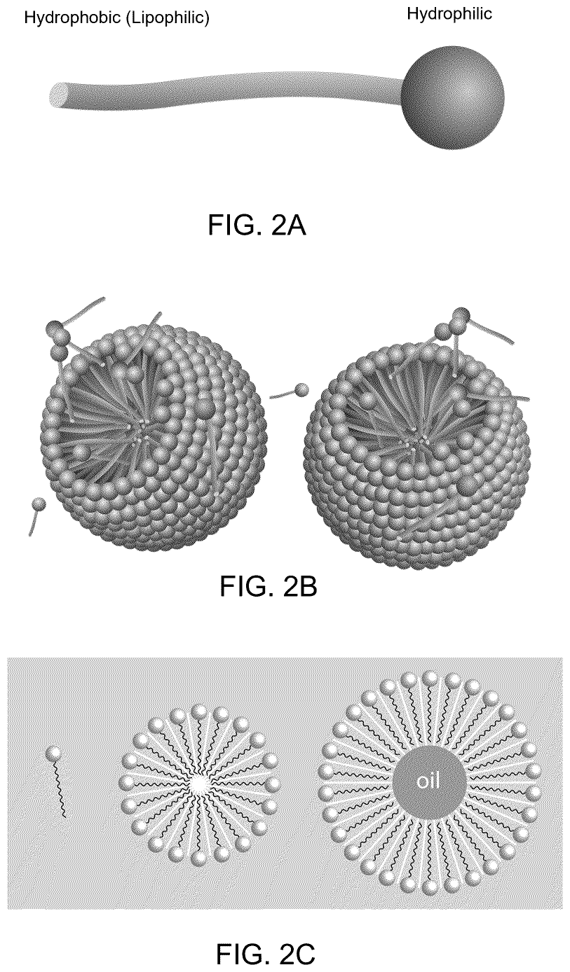

As discussed herein, surfactants, e.g., polysaccharides, are amphiphiles. As illustrated in FIG. 2A, amphiphiles are compounds that possess both hydrophilic, i.e., water loving (polar), and lipophilic, i.e., oil or fat loving (non-polar) components.

Thus, surfactants are generally characterized by their chemistry, e.g. polar moiety. The hydrophilic-lipophilic balance (HLB) determines the nature of the surface activity (i.e., ability to dissolve in water, oil, or oil and water, or even balance).

Surfactants play a role (e.g. absorb) at the interfaces such as, water-oil, liquid-gas, solid-liquid, where they find the energetically most favorable conditions due to their two-part structure, to lower the surface activity. Thus, when a surfactant is present, in a two phased system, the concentration of surfactant adsorbed at the interface increases, and the interfacial tension decreases.

At the interface, the polar head groups interact with water while the non-polar lipophilic chain migrate above, disturbing the cohesive energy at the interface, forming many micelles, as illustrated in FIG. 2B.

The characteristic behavior of polysaccharide with surfactant is similar to surfactant micellization in solution. It is known that the hydrophobic character of both the polysaccharide polymer and surfactant is responsible for the interactions.

As illustrated in FIG. 2C, the association of polysaccharide molecules and bio-surfactant leads to the formation of matrix complexes that have better emulsifying properties, and form more compact adsorption layers at the interface of oil droplets, creating strong micelles, thus facilitating the encapsulation of liquid and gas at the air-liquid interface, which once the fire is extinguished, is preventing reignition.

In some embodiments, the botanical material is taken directly from a plant without further processing (e.g., concentration or treatment). In some embodiments, the extract comprises a material that has been further processed (e.g., by concentration, drying, purification, isolation, etc.). In some embodiments, aloe vera in its gel form (e.g., aloe vera juice form) is used as a botanical material base for the composition. In some embodiments, the aloe vera comprises and/or consists of pure aloe barbadensis leaf juice (e.g., a botanical gel). In some embodiments, the aloe vera comprises and/or consists of aloe barbadensis leaf gel. In some embodiments, the botanical material is an aloe extract such as one or more of BiAloe®, Naturaloe, and/or Aloecorp bioactive aloe. In some embodiments, the aloe vera comprises and/or consists of aloe barbadensis leaf gel, semi solid, liquid or liquid aloe vera plant extract. In some embodiments, the aloe vera comprises and/or consists of an aloe vera extract powder (e.g., BiAloe®). In some embodiments, as discussed elsewhere herein, the botanical material comprises and/or is

BiAloe®, and/or reconstituted BiAloe® powder. BiAloe® is a commercial aloe extract available from Loraland Laboratories. In some embodiments, BiAloe® has an average acemannan wt % of 18%. In some embodiments, about 15.5% of the acemannan fraction in BiAloe® is less than 400 kDa and about 7.1% of the acemannan fraction is less than 50 kDa. In some embodiments, BiAloe® has a polysaccharide content of about 20%. In some embodiments, BiAloe® has a full spectrum of molecular weight polysaccharides. In some embodiments, as described herein elsewhere, the botanical material powder can be reconstituted with water to prepare the temperature suppressing agent and/or a water delivery concentrate.

In some embodiments, the amount of temperature suppressing agent, and/or water delivery agent (such as botanical material) on the composition is expressed as a weight percentage of the dry material (e.g., powder aloe extract, BiAloe®, etc.) in composition. For example, where 1 g of dry botanical material is added to 99 g of water, the weight percent of the botanical material is 1% (1 g dry material/100 g total composition×100). In some embodiments, the weight percent of temperature suppressing agent and/or water delivery agent (e.g., botanical material, aloe extract powder, BiAloe®, etc.) in the fire suppressing and/or extinguishing composition concentrate is equal to or less than about: 0.01%, 0.1%, 0.25%, 0.3%, 0.5%, 1.0%, 4.0%, 5.0%, 10%, 25%, or ranges including and/or spanning the aforementioned values. In some embodiments, the weight percent of temperature suppressing agent/and or water delivery agent in the composition concentrate is equal to or at least about: 0.001%, 0.01%, 0.03%, 0.05%, 0.1%, 0.25%, 0.50%, 1.0%, 2.5%, 5%, 7.5%, or ranges including and/or spanning the aforementioned values. In some embodiments, the weight percent of temperature suppressing agent and or water delivery agent in the dilute fire suppressing and/or extinguishing composition is equal to or less than about 0.001%, 0.01%, 0.03%, 0.05%, 0.10%, 0.40%, 0.50%, 1.0%, 2.5% or ranges including and/or spanning the aforementioned values. In some embodiments, the weight percent of temperature suppressing agent and/or water delivery agent in the dilute composition is equal to or at least about: 0.0001%, 0.001%, 0.003%, 0.005%, 0.01%, 0.10%, 0.25%, 0.50%, 0.75%, or ranges including and/or spanning the aforementioned values. Where a plurality of temperature suppressing agents and/or water delivery agents are used (e.g., 2, 3, 4, 5, or more), their individual weight percent % values can be independently selected from the weight percent values disclosed herein. In some embodiments, the weight percent of aloe vera powder, or powdered botanical material or other temperature suppressing agent and/or water delivery agent) in the concentrated fire suppressing and/or extinguishing composition is equal to or at least about: 0.01%, 0.1%, 0.25%, 0.3%, 0.5%, 1.0%, 4.0%, 5.0%, 10%, 25%, 50%, 75%, or ranges including and/or spanning the aforementioned values.

In some embodiments, as mentioned above, where an aloe vera extract is used (e.g. a powdered extract such as BiAloe®), it can be reconstituted before use. In some embodiments, for example, 0.228 oz of powdered aloe plant extract (e.g. BiAloe®) is mixed with 60 oz of distilled water to prepare the botanical material for use in the fire suppressing and/or extinguishing composition. In some embodiments, the weight percent (wt %) of powder aloe vera extract (e.g., BiAloe®) in water used to form the botanical material (e.g., a reconstituted botanical material) is equal to or less than about: 0.01%, 0.1%, 0.3%, 0.5%, 1.0%, 4.0%, 5.0%, 10%, 25%, 50%, 75%, or ranges including and/or spanning the aforementioned values. In some embodiments, the weight percent of reconstituted botanical material in the concentrate or the diluted formation is as described elsewhere herein. For example, in some embodiments, as described elsewhere herein, the wt % of botanical material (e.g., reconstituted aloe vera extract, etc.) in the fire suppressing and/or extinguishing composition concentrate is equal to or less than about: 5%, 10%, 25%, 50%, 70%, 75%, 85%, 95%, or ranges including and/or spanning the aforementioned values. In some embodiments, the weight percent of botanical material (e.g., reconstituted aloe vera extract, etc.) in the fire suppressing and/or extinguishing composition after dilution (e.g., with water) is equal to or less than about: 0.1%, 0.2%, 0.5%, 1.0%, 2.5%, 5.0%, 7.0%, 9.5%, or ranges including and/or spanning the aforementioned values. In some embodiments, the weight percent (wt %) of powdered aloe vera extract (e.g., BiAloe®) in the fire suppressing and/or extinguishing composition after dilution (e.g., with water) is equal to or less than about: 0.001%, 0.01%, 0.03%, 0.05%, 0.1%, 1.0%, 2.5%, 5.0%, 7.5%, or ranges including and/or spanning the aforementioned values.

In some embodiments, as disclosed elsewhere within, the temperature suppressing agent and/or water delivery agent of the fire suppressing and/or extinguishing composition comprises botanical powder (e.g., extracted material from an aloe vera plant, such as BiAloe®, etc.). In some embodiments the powder is an aloe vera powder. In some embodiments, the aloe vera powder is prepared by drying organic inner leaf aloe vera or aloe vera leaf juice. In some embodiments, the botanical powder is prepared by drying organic plant material. In some embodiments, aloe vera juice is dehydrated and then subject to a milling or powderization process to provide aloe vera powder. In some embodiments, the temperature suppressing agent and/or a water delivery agent (e.g., powdered aloe vera extract, BiAloe®, acemannan, etc.), or the plurality of agents, is mixed with water (e.g., reconstituted) to prepare the concentrated temperature suppressing agent and/or a water delivery agent.

In some embodiments, the weight percent of aloe vera powder in the concentrated fire suppressing and/or extinguishing composition a value as disclosed elsewhere herein and/or can be equal to or at least about 0.01%, 0.25%, 0.3%, 0.5%, 1.0%, 4.0%, 5.0%, 10%, or ranges including and/or spanning the aforementioned values. In some embodiments, the weight percent of aloe vera powder (or other powder agent temperature suppressing agent and/or a water delivery agent) in the concentrated fire suppressing and/or extinguishing composition can be a value as disclosed elsewhere herein and/or can be equal to or less than about: 0.001%, 0.01%, 0.1%, 0.3%, 0.5%, 1.0%, 4.0%, 5.0%, 10%, or ranges including and/or spanning the aforementioned values. As an illustration, where the fire suppressing and/or extinguishing composition consists of only 5 g of aloe vera powder and 95 g of water, the aloe vera powder is provided at a weight percent of 5%, and the concentrated fire suppressing and/or extinguishing composition comprises water at a weight percent of 95%. In some embodiments, as disclosed elsewhere herein, water is added to the powdered temperature suppressing agent and or water delivery agent as a reconstituting agent. In some embodiments, the weight percent of water in the reconstituted temperature suppressing agent and/or a water delivery agent is equal to or at least about: 40%, 60%, 80%, 90%, 98%, 99.9%, 99.99% or ranges including and/or spanning the aforementioned values. In some embodiments, the weight percent of aloe vera powder (or other temperature suppressing agent and/or a water delivery agent powdered agent) in the diluted fire suppressing and/or extinguishing composition is equal to or at least about: 0.001%, 0.01%, 0.03%, 0.05%, 0.1%, 1.0%, 2.5%, 5.0%, 7.5%, or ranges including and/or spanning the aforementioned values.

In some embodiments, the amount of polysaccharides in the fire suppressing and/or extinguishing composition is expressed as weight % of the dry material in the formulation. In some embodiments, the weight percent of polysaccharide in the fire suppressing and/or extinguishing composition concentrate is equal to or less than about: 0.01%, 0.1%, 0.25%, 0.3%, 0.5%, 1.0%, 4.0%, 5.0%, 10%, 25%, or ranges including and/or spanning the aforementioned values. In some embodiments, the weight percent of polysaccharides in the composition concentrate is equal to or at least about: 0.001%, 0.01%, 0.03%, 0.05%, 0.1%. 0.25%, 0.5%, 1.0%, 2.5%, 5.0%, 7.5%, or ranges including and/or spanning the aforementioned values. In some embodiments, the weight percent of polysaccharides in the composition concentrate is equal to or at least about: 0.001%, 0.01%, 0.03%, 0.05%, 0.1%, 0.25%, 0.50%, 1.0%, 2.5%, 5.0%, or ranges including and/or spanning the aforementioned values. In some embodiments, the weight percent of polysaccharide in the dilute fire suppressing and/or extinguishing composition is equal to or less than about: 0.001%, 0.01%, 0.03%, 0.05%, 0.10%, 0.40%, 0.50%, 1.0%, 2.5%, or ranges including and/or spanning the aforementioned values. In some embodiments, the weight percent of polysaccharide in the dilute composition is equal to or at least about: 0.0001%, 0.001%, 0.003%, 0.005%, 0.01%, 0.10%, 0.25%, 0.50%, 0.75%, or ranges including and/or spanning the aforementioned values. Where a plurality of polysaccharides is used, (e.g., 2, 3, 4, 5, or more), their individual weight % values can be independently selected from the weight % values disclosed herein.

In some embodiments, the amount of cellulosic material in the fire suppressing and/or extinguishing composition is expressed as a weight % of the dry material. In some embodiments, the weight percent of cellulosic material in the fire suppressing and/or extinguishing composition concentrate is equal or less than about: 0.01%, 0.1%, 0.25%, 0.3%, 0.5%, 1.0%, 4.0%, 5.0%, 10%, 25% or ranges including and/or spanning the aforementioned values. In some embodiments, the weight percent of cellulosic material in the dilute fire suppressing and/or extinguishing composition is equal to or less than about: 0.0001%, 0.001%, 0.003%, 0.005%, 0.01%, 0.10%, 0.25%, 0.50%, 0.75% or ranges including and/or spanning the aforementioned values. Where a plurality of cellulosic materials is used, (e.g., 2, 3, 4, 5, or more), their individual weight percent values can be independently selected from the weight % values disclosed herein.

In some embodiments, the fire suppressing and/or extinguishing composition comprises an acemannan source (e.g., aloe vera, alternative plant sources, etc.) and or acemannan (e.g., a dissolved powder extract of acemannan). Acemannan is a D-isomer mucopolysaccharide in aloe vera leaves and is a hydrophilic polymer. Acemannan is recognized by the FDA as natural product. It can be isolated from natural aloe vera to form a process stabilized powder that contain all the active characteristics of the complex carbohydrates or acetylated mannans and found in fresh aloe vera gel. Aloe Vera (and Acemannan) also contain organic acids (e.g., galacturonic acid, etc.), that exhibit and/or lend unique properties to the formulation (e.g., good viscosity, high swelling capabilities, water retention, etc.). Acemannan interacts synergistically with xanthan gum; The two polysaccharides in solution, impart high viscosity at low concentrations, and show to be very stable when high salt content is added (for example when the concentrated fire suppression and/or fire extinguishing composition is diluted with saltwater).

Without being bound to any mechanism, it is believed that acemannan functions as a temperature reducing agent and/or water delivery material in the fire suppressing and/or extinguishing composition.

In some embodiments, the weight percent of dry acemannan used in the concentrated fire suppressing and/or extinguishing composition is as described above for the temperature suppressing agent and/or water delivery agent. In some embodiments, the wt % of acemannan in the fire suppressing and/or extinguishing composition concentrate is equal to or less than about: 0.01%, 0.05%, 0.1%, 0.25%, 0.5%, 1.0%, 2.5%, 5.0%, 10%, 25% or ranges including and/or spanning the aforementioned values. In some embodiments, the wt % of acemannan in the fire suppressing and/or extinguishing composition concentrate is equal to or greater than about: 0.01%, 0.05%, 0.1%, 0.2%, 0.5%, 1.0%, 2.5%, 5.0%, 7.0%, 9.5%, or ranges including and/or spanning the aforementioned values. In some embodiments, the wt % of acemannan in the fire suppressing and/or extinguishing composition after dilution (e.g., with water) is equal to or less than about: 0.001%, 0.01%, 0.03%, 0.05%, 0.1%, 1.0%, 2.5%, 5.0%, 7.5%, or ranges including and/or spanning the aforementioned values.

In some embodiments, the concentrate comprises a hydrocolloid (e.g., gelling agent, a hydrogel forming, a water-soluble gum and hydrophilic polymer) capable of swelling and delivering water to the fire fuel source. In some embodiments, the hydrocolloid is a polysaccharide as disclosed elsewhere herein. In some embodiments, the temperature suppressing agent and/or water delivery agent of the concentrate comprises a hydrogel-forming and/or hydrophilic polymer. Without being bound to any mechanism, it is believed that hydrogel-forming and/or hydrophilic polymers function as temperature reducing agents and/or water delivery materials in the fire suppressing/and or extinguishing composition. These can be used in addition to, or instead of acemannan and/or aloe vera. In some embodiments, the weight percent of a wet hydrogel-forming and/or hydrophilic polymer(s) (e.g., the weight percent of hydrated hydrogel) in the fire suppressing and/or extinguishing concentrate is equal to at least about: 10%, 20%, 40%, 60%, 70%, 80%, 90%, or ranges including and/or spanning the aforementioned values. In some embodiments, the wt % hydrogel-forming and/or hydrophilic polymer(s) in the fire suppressing and/or extinguishing composition is equal to or at least about: 0.01%, 0.1%, 0.3%, 0.5%, 1.0%, 10%, 25%, 50%, 75%, 80%, 95%, or ranges including and/or spanning the aforementioned values. In some embodiments, the wt % hydrogel-forming and/or hydrophilic polymer(s) in the diluted fire suppressing and/or extinguishing concentrate is equal to or at least about: 0.001%, 0.01%, 0.03%, 0.05%, 0.10%, 1.0%, 2.5%, 5.0%, 7.5%, or ranges including and/or spanning the aforementioned values.

In some embodiments, the hydrogel-forming and/or hydrophilic polymer is a polysaccharide. In some embodiments, the hydrogel-forming and/or hydrophilic polymer is the polysaccharide as disclosed elsewhere herein. In some embodiments, the hydrogel-forming and/or hydrophilic polymer is a combination of polysaccharides, with specific characteristics, charges, enabling the formation of micelles when mixed with chosen bio-surfactants. The hydrogel-forming and/or hydrophilic polymer/bio-surfactant mixture are able to form adsorption layers at the surface of oil droplets, therefore enhance the emulsion stability of the fire suppressing and/or extinguishing composition. When an oppositely charged polymer is added to the bio-surfactant solution, this forms a steric barrier which prevents coalescence and helps the stability of the foam, preventing its disruption, therefore enabling the encapsulation of the fuel and preventing re-ignition. In some embodiments, the hydrogel forming and/or hydrophilic polymer is not a polysaccharide. In some embodiments, the hydrogel forming and/or hydrophilic polymer comprises one or more of acemannan, hyaluronic acid, collagen, starch, alginate, agarose, guar gum or the like. As used herein, bio-surfactant comprises one or more of coco betaine and/or sodium cocoamphoacetate, and/or glycine betaine.

In some embodiments, the acemannan, aloeride, polysaccharides, cellulosic material, aloe extract, components (and/or hydrogel-forming and or hydrophilic polymers) are selected based on their molecular weight. In some embodiments, the molecular weight of the hydrogel-forming and/or hydrophilic polymers in the fire suppression and/or extinguishing composition have a mass in Daltons (Da) of equal to or at least about: 10000, 50000, 100000, 1000000, 1300000, 2000000, 3000000, 4000000, 5000000, 6000000, 7000000, or ranges including and/or spanning the aforementioned values.

In some embodiments, the fire suppressing and/or extinguishing composition (e.g., the concentrate or the diluted concentrate) can comprise one or more thickening agent, one or more surfactants, one or more humectants, one or more agents that prevents the crystallization of water (e.g., antifreeze agent), and/or one or more pH adjusting agent. It should be appreciated that these ingredients, individually or collectively may or may not be present in the fire suppressing and/or extinguishing composition. Thus, as described above, in some embodiments, the fire suppressing and/or extinguishing composition lacks a thickening agent, a surfactant, a humectant, an agent that prevents the crystallization of water (e.g., an antifreeze agent), and/or a pH adjusting agent.

As disclosed elsewhere herein, in some embodiments, the composition comprises one or more thickening agents. In some embodiments, the thickening comprises a polysaccharide and/or a cellulosic material (such as celluloses and their derivatives) as disclosed elsewhere herein. In some embodiments, the thickening agent comprises one or more of gellan gum, guar gum, carbomer (e.g., carbomer 940/980), xanthan gum, gum Arabic, pectin, acacia gum, dried exudate from the stems and branches of the acacia tree (e.g., polysaccharides, starches, glucuronic acid, galacturonic acid, etc.), and/or hydroxypropyl guar (e.g., which is a non-ionic polymer made of naturally occurring guar, Cyamopsis tetragonoloba). These gums also have emulsifying properties for oil in water emulsions (which helps with the encapsulation properties of the formulation). In some embodiments, the thickening agent comprises a polysaccharide or cellulosic material as disclosed above. For example, in some embodiments, a botanical material is provided as the temperature suppressing and/or water delivery agent, and a polysaccharide as a thickener. In some embodiments, one polysaccharide is used as the temperature suppressing agent and/or water delivery agent and another polysaccharide as a thickener. In some embodiments, a single or multiple polysaccharide (e.g. 2, 3, 4, 5, or more) are used together to serve a dual purpose as a temperature suppressing agent and/or water delivery agent and thickener.

In some embodiments, the weight percent of the thickening agent or thickening agents in the fire suppressing and/or extinguishing concentrate, individually or collectively, is equal to or at least about: 0.01%, 0.1%, 1.0%, 2.5%, 5.0%, 10%, 20%, 25%, 30%, or ranges including and/or spanning the aforementioned values. In some embodiments, the weight percent of the thickening agent or thickening agents in the fire suppressing and/or extinguishing concentrate, individually or collectively, is equal to or less than about: 0.01%, 0.1%, 0.3%, 0.5%, 1.0%, 2.5%, 5.0%, 10%, 20%, 25%, 30%, or ranges including and/or spanning the aforementioned values. In some embodiments, the weight percent of the thickening agent or thickening agents in the diluted fire suppressing and/or extinguishing composition, individually or collectively is equal to or at least about: 0.001%, 0.01%, 0.025%, 0.05%, 0.5%, 1.0%, 2.0%, 2.5%, 3.0%, or ranges including and/or spanning the aforementioned values. In some embodiments, the weight percent of the thickening agent in the diluted fire suppressing and/or extinguishing composition individually or collectively, is equal to or less than about: 0.001%, 0.01%, 0.025%, 0.05%, 0.1%, 2.0%, 2.5%, 3.0%, or ranges including and/or spanning the aforementioned values.

In some embodiments, as disclosed elsewhere herein, a soluble or swellable polysaccharide is used as a thickening agent (e.g., xanthan gum, a cellulosic material, etc.) because its water solubility and its ability to swell (e.g., as a swellable thickening agent). In some embodiments, thickening agents (e.g., as a swellable thickening agent) aid in causing a foam to form a gel when the composition comes into contact with a polar hydrophilic liquid (e.g. alcohols, ketones, etc.). In some embodiments, the thickening agent acts as a barrier towards the fuel vapors and liquids and prevents the foam blanket from breaking. In some embodiments, 1,3-propanediol is used as a thickening agent. In some embodiments, 1,3-propanediol is not used as a thickening agent.

While several embodiments described herein comprise a thickening agent, in some embodiments, the fire suppressing and/or extinguishing composition lacks a thickening agent, including any one or more of the thickening agents disclosed elsewhere herein.

As disclosed elsewhere herein, in some embodiments, the composition comprises one or more bio-surfactants. In some embodiments, the surfactant reduces water surface tension and/or aids in foaming the composition. In some embodiments, the surfactant helps the composition form a foam blanket when mixed with air (e.g., when the composition is deployed). In some embodiments, it has been noted that compositions comprising surfactants can extinguish fires faster than those without surfactants. Molecules of surfactants adhere to interfaces (e.g., water-oil, liquid-gas, and solid-liquid or gas) and lower their surface energy (i.e., interfacial tension). For example, adding a surfactant to a two-phase system (e.g., water-oil) will increase the concentration of surfactant adsorbed at the liquid-liquid interface, thus decreasing the surface energy (i.e. interfacial tension), until the interface becomes saturated in surfactant known as the critical micelle concentration (CMC). The excess of surfactant creates self-assembly systems such as micelles. Those micelles are the first step to encapsulation of the fuel, and annihilation of high energy free radicals. (in combustion, free radicals have very high energy and high velocity impact with combustible substances. They then release more energy to prompt reaction and produce more free radicals).

The addition of surfactant decreases the surface tension of water, enhancing penetration of water molecules and creating a foam blanket on the fuel, thus obstructing the combustion of oil steam.

Bio-surfactant are chosen in one or more embodiments of the invention composition for environmental reasons. The ideal surfactants will induce a low surface tension, will have high solubility in water and/or oil, will have insensitivity to temperature, salinity, or other environmental factors, fast kinetics for self-assembly, high biodegradability and biocompatibility. In addition, ideal surfactants will produce high foam at low levels and aid in building viscosity of surfactant-based composition.

In one or more embodiments, the compositions comprise anionic compounds (e.g. surfactants) as well as cationic versions of the compounds in balanced concentrations.

In some embodiments, the surfactant comprises one or more of coco betaine (e.g., cocamidopropyl betaine), esterquat, lysophosphatidylcholine, laurylamidopropyl hydroxysultaine, decyl glucoside (or polyglucose) (non-ionic), sodium lauroyle lactilate, sodium oleate, potassium laureate, alpha olein sulfonate, cocoglucose, sodium cocoamphoacetate (amphoteric), lauryl glycoside (non-ionic), sodium cocoyl glutamate (anionic) and/or sodium lauryl glucose carboxylate (anionic), sodium laureth sulfate (“SLES”) (anionic), sulfoccinate (anionic), cocamidopropylamine oxide.

In some embodiments, anionic, cationic, and or neutral (non-ionic) surfactants can be used. In some embodiments, the surfactant will be chosen for its ability to bind with the polysaccharides in the fire extinguishing composition, to create the best environment for emulsion, foam stability, micelle formation and encapsulation of the fuel.

In some embodiments, the composition further comprises cationic polymers such as guar hydroxypropyltrimonium chloride (a water-soluble quaternary ammonium derivative of guar gum), cationic xanthan gum, etc.

In one or more embodiments, the compositions can comprise a botanical material such as aloe vera or extract thereof and one or more additional chemical components/agents. The additional chemical components can include a low freeze temperature agent such as potassium lactate, a thickening/binding agent such as propanediol (e.g., 1,3-propanediol), a bio-based surfactant such as cocamidopropyl betaine, polysaccharides such as xanthan gum, guar gum or derivatives thereof, a pH adjusting agent such as triethanolamine, sodium gluconate, foaming agents, foam stabilizers, emulsifying agents, chelating agents, emollients, preservatives, bamboo extracts, algae extracts, Santalum acuminatum, Citrus glauca, wattle seed extract, cactus extract, psicose and water.

Because of the increasing need to incorporate renewable carbon responsibility in products to reduce carbon footprint, improve sustainability and alleviate environmental concerns, one or more embodiments of the present invention incorporates bio-based surfactants (“biosurfactants”).

Biosurfactants are derived in whole or significant part from biological products or renewable agricultural materials (e.g., plants, vegetable, marine materials).

Amphoteric surfactants possess both positive and negative charged groups in the same molecule. Betaine surfactants are zwitterionic. The key functional groups in the chemical structure of Betaines are the quaternized nitrogen and the carboxylic group. Amphoteric biosurfactant like Betaines offer good foam density and stability in hard water, unlike anionic surfactants.

Betaine also foams at pH extremes. It is believed that Alkyl and Alkyl Amido Betaines show synergy with anionic polyelectrolytes like xanthan gum, by increasing the packing density and stabilizing the interface. It is believed that the zwitterionic biosurfactants helps screen the charge carried by the anionic polyelectrolyte (e.g. xanthan gum) at the interface, resulting in closer packing of surfactant. The closer packing would increase the charge density and the resulting electrostatic repulsions, preventing film coalescence. The closer packing of biosurfactant-polyelectrolytes molecules at the interface, also increase the surface shear viscosity, stabilize the emulsion, thus enables encapsulation by inducing adsorption of the surfactant onto the polymer.

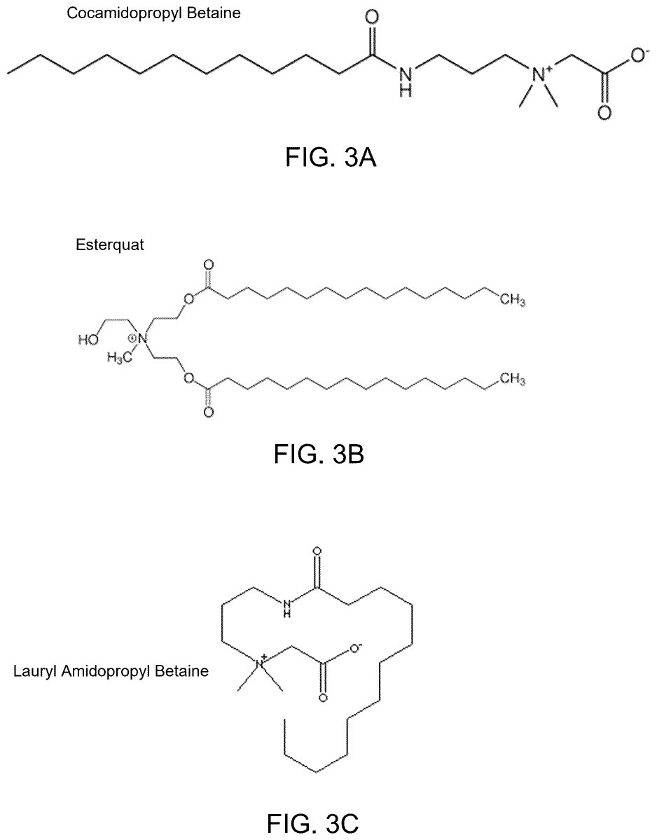

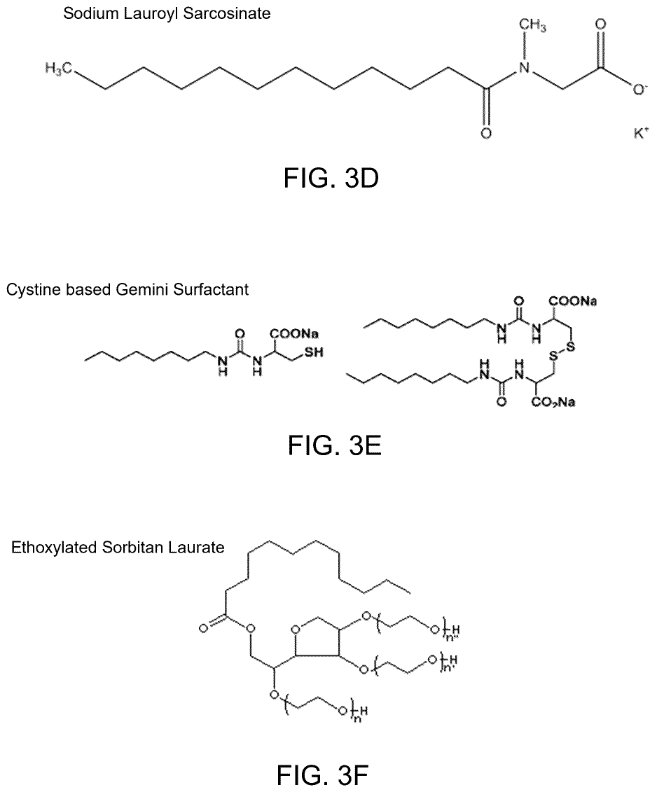

FIGS. 3A-F are illustrations of the chemical structures of various bio-based surfactants used in embodiments of the present invention. FIG. 3A is Cocamidopropyl Betaine; 3B is Esterquat; 3C is Lauryl Amidopropyl Betaine; 3D is Sodium Lauroyl Sarcosinate; 3E is Cystine based Gemini Surfactant; and 3F is Ethoxylated Sorbitan Laurate.

In some embodiments, the weight percent of the surfactant or surfactants in the fire suppressing and/or extinguishing composition concentrate, individually or collectively is equal to or at least about: 0.1%, 1%, 4%, 10%, 15%, 20%, 30%, 40%, 50%, 60%, or ranges including and/or spanning the aforementioned values. In some embodiments, the weight percent of the surfactant or surfactants, in the diluted fire suppression and/or extinguishing composition, individually or collectively, is equal to or less than about 0.1%, 1%, 4%, 5%, 10%, 15%, 20%, 30%, 40%, 50%, 60%, or ranges including and/or spanning the aforementioned values. In some embodiments, the weight percent of the surfactant or surfactants in the diluted fire suppressing and/or extinguishing composition, individually or collectively is equal to or at least about: 0.1%, 0.4%, 0.5%, 1.0%, 1.5%, 2.0%, 3.0%, 4.0%, or ranges including and/or spanning the aforementioned values. In some embodiments, the weight percent of the surfactant or surfactants in the diluted fire suppressing and/or extinguishing composition, individually or collectively, is equal to or less than about: 0.1%, 0.4%, 0.5%, 1.0%, 1.5%, 2.0%, 3.0%, 4.0%, or ranges including and/or spanning the aforementioned values. In some embodiments, the fire suppressing and/or extinguishing composition lacks a surfactant.

In some embodiments, coco betaine is selected as the bio-surfactant (or as one of the surfactants) because of its high level of biodegradability and biocompatibility. In some embodiments, coco betaine has both wettability and foaming properties (for foam and foam stability) and good viscosity building. The foam is particularly resistant to hard water and extreme pH. In some embodiments, coco betaine is selected as a surfactant due to its amphoteric properties and/or compatibility with anionic, non-ionic, and other cationic surfactants. Amphoteric surfactants possess both positive and negative charged groups in the same molecule. Coco betaine is also a good foam booster and it is derived from coconut oil and is water soluble (with a pH of 5 to 6).

In some embodiments, the surfactant is decyl glucoside sodium lauroyl lactylate. decyl glucoside lauroyl lactylate is a non-ionic surfactant blend consisting of decyl glucoside and sodium lauroyl lactylate. Decyl glucoside can be made from coconut and corn starch. Sodium lauroyl lactylate is the sodium salt of lactic acid. In some embodiments, sodium oleate and/or potassium laurate can be used as a surfactant.

In some embodiments, a surfactant used for the composition is coco glucoside. Coco glucoside is a non-ionic surfactant that can be used as a foaming, cleansing, conditioning, and viscosity boosting agent.

In some embodiments, a surfactant used for the composition is Sodium C14-16 Alpha Olefin Sulfonate (“AOS”). Sodium C14-16 Alpha Olefin Sulfonate is an anionic surfactant that is a mixture of long chain sulfonate salts prepared by sulfonation of C14-16 alpha olefins. It can be derived from coconut and produces a copious foam. It consists chiefly of sodium alkane sulfonates and sodium hydroxy alkane sulfonates.

In some embodiments, the composition comprises one or more of the non-ionic and anionic surfactants (e.g., Decyl glucoside, coco glucoside, Sodium C14-16 Alpha Olefin Sulfonate). In some embodiments, the surfactant has a viscosity boosting properties, and/or has good compatibility with other surfactants including non-ionic, amphoteric, or anionic co-surfactants. In some embodiments, the weight percent of the surfactant(s) (e.g., Decyl glucoside, coco glucoside, Sodium C14-16 Alpha Olefin Sulfonate, sodium cocoamphoacetate, lauryl glycoside, sodium cocoyl glutamate, and/or sodium lauryl glucose carboxylate, individually or collectively), in the fire extinguishing composition is equal to or at least about: 1%, 4%, 5%, 10%, 15%, 20%, 25%, 30%, 35%, 40%, or ranges including and/or spanning the aforementioned values.

In some embodiments, a surfactant comprises a mild anionic, foaming, and/or emulsifying surfactant (e.g., alpha olein sulfonate). Alpha olein sulfonate is made primarily from coconut oils. In some embodiments, the surfactant has a wetting effect, foam booster properties, and/or has good compatibility with other surfactants including non-ionic, amphoteric, or anionic co-surfactants. In some embodiments, the weight percent of alpha olein in the concentrated fire suppressing and/or extinguishing composition is equal to or less than about: 1%, 4%, 5%, 10%, 15%, 20%, 25%, 30%, 35%, 40%, or ranges including and/or spanning the aforementioned values. In some embodiments, the weight percent of alpha olein sulfonate in the diluted fire suppressing and/or extinguishing compositions is equal to or less than about: 0.1%, 0.4%, 0.5%, 1.0%, 1.5%, 2.0%, 3.0%, 4.0%, or ranges including and/or spanning the aforementioned values. In some embodiments, the weight percent of the surfactant(s) (e.g., coco glucoside, sodium cocoamphoacetate, lauryl glycoside, sodium cocoyl glutamate, and/or sodium lauryl glucose carboxylate, individually or collectively), in the diluted fire suppressing and/or extinguishing composition is equal to or at least about: 0.1%, 0.4%, 0.5%, 1.0%, 1.5%, 2.0%, 3.0%, 4.0%, or ranges including and/or spanning the aforementioned values. In some embodiments, the weight percent of the surfactant(s) (e.g., coco glucoside, sodium cocoamphoacetate, lauryl glycoside, sodium cocoyl glutamate, and/or sodium lauryl glucose carboxylate individually or collectively) in the concentrated composition is disclosed elsewhere herein.

While several embodiments described herein comprises one or more surfactants, in some embodiments, the fire suppressing and/or extinguishing composition lacks a surfactant, including any one or more of the surfactants disclosed elsewhere herein.

As disclosed elsewhere herein, in some embodiments, the composition comprises one or more humectants. Some embodiments of the composition comprise one or more emollients (e.g., humectants and/or wetting agents). In some embodiments, the humectant comprises one or more of 1,3-propanediol, 1,2-propanediol and/or isopropyl isostearate. In some embodiments, the composition lacks 1,2-propanediol (e.g., propylene glycol). In some embodiments, the weight percent of the humectant or humectants in the concentrated fire suppressing and/or extinguishing composition, individually or collectively, is equal or at least about: 1%, 5%, 10%, 15%, 20%, 25%, 35%, or ranges including and/or spanning the aforementioned values. In some embodiments, the weight percent of the humectant or humectants in the diluted fire suppressing and/or extinguishing composition, individually or collectively, is equal to or at least about: 0.05%, 0.1%, 0.5%, 1.0%, 1.5%, 2.0%, 2.5%, 3.5%, or ranges including and/or spanning the aforementioned values. In some embodiments, the weight percent of the humectant or humectants in the diluted fire suppression and/or extinguishing composition, individually or collectively, is equal to or less than about: 0.05%, 0.1%, 0.5%, 1.0%, 1.5%, 2.0%, 2.5%, 3.5%, or ranges including and/or spanning the aforementioned values. In some embodiments, where used, the 1,3-propanediol also adds fluidity properties, antifreeze properties, and/or a preservative boosting efficacity.

In some embodiments, propanediol advantageously affects the performances of the bio-surfactant. The hydrophile-lipophile balance (HLB) value of surfactant is important to predict performance of, for example, emulsifiers, solubilizers and wetting agents. The HLB value is important to predict the micellization, and encapsulation at the interface. The micellization of surfactants in aqueous solution is regulated by the balance between two opposing forces: the cohesive force between the hydrophobic groups, and the attractive forces between the hydrophilic groups and water molecules. In some embodiments it is believed that 1,3-propanediol raises the HLB value of the surfactant in solution, therefore its water solubility. In some embodiments, it is believed that 1,3-propanediol advantageously affects the conformation of the polysaccharide or botanical in solution, allowing it to expand and deliver water more effectively. In some embodiments, it is believed that 1,3-propanediol enhances the heat adsorption capacity of the fire suppressing and/or extinguishing composition.

In some embodiments, the humectant comprises glycerol. In some embodiments, the humectant lacks glycerol. In some embodiments, the fire suppressing and/or extinguishing composition lacks a humectant.

While several embodiments described herein comprise a humectant, in some embodiments, the fire suppressing and/or extinguishing composition lacks a humectant, including any or more of the humectants disclosed elsewhere herein.

As disclosed elsewhere herein, the composition comprises one or more low freezing agent. The low freezing agent comprises Potassium lactate 60% in water solution, sodium lactate 60% in water solution. In some embodiments, the weight percent of the low freezing agent or low freezing agents in the fire suppressing and/or extinguishing concentrate, individually or collectively, is equal to or at least about: 0.01%, 0.1%, 1.0%, 2.5%, 5.0%, 10%, 20%, 25%, 30%, or ranges including and/or spanning the aforementioned values. In some embodiments, the weight percent of the low freezing agent or low freezing agents in the fire suppressing and/or extinguishing concentrate, individually or collectively, is equal to or less than about: 0.01%, 0.1%, 0.3%, 0.5%, 1.0%, 2.5%, 5.0%, 10%, 20%, 25%, 30%, or ranges including and/or spanning the aforementioned values. In some embodiments, the weight percent of the low freezing agent or low freezes agents in the diluted fire suppressing and/or extinguishing composition, individually or collectively is equal to or at least about: 0.001%, 0.01%, 0.025%, 0.05%, 0.5%, 1.0%, 2.0%, 2.5%, 3.0%, 3.5%, 4.0%, 4.5%, 5.0%, or ranges including and/or spanning the aforementioned values. In some embodiments, the weight percent of the low freezing agent in the diluted fire suppressing and/or extinguishing composition individually or collectively, is equal to or less than about: 0.001%, 0.01%, 0.025%, 0.05%, 0.1%, 2.0%, 2.5%, 3.0%, 3.5%, 4.0%, 4.5%, 5.0%, or ranges including and/or spanning the aforementioned values.

As disclosed elsewhere herein, in some embodiments, the composition comprises one or more pH adjusting agents. In some embodiments, the pH adjusting agent comprises one or more of triethylamine, triethanolamine, sodium gluconate, gluconic acid, and/or citric acid. Sodium gluconate is the sodium salt of gluconic acid. In addition to pH adjusting capabilities, sodium gluconate has chelating properties over a wide pH range and/or it also reacts as a pH regulator as well as a humectant. Citric acid is naturally produced (e.g., by fermentation of carbohydrates) and is another biocompatible pH adjusting agent. In some embodiments, the weight percent of the pH adjusting agent or pH adjusting agents in the fire suppressing and/or extinguishing concentrate, individually or collectively, is equal to or at least about: 0.01%, 0.1%, 1%, 2%, 3%, 5%, or ranges including and/or spanning the aforementioned values. In some embodiments, the weight percent of the pH adjusting or pH adjusting agents in the diluted fire suppression and/or extinguishing composition, individually or collectively, is equal to or at least about: 0.001%, 0.01%, 0.1%, 0.2%, 0.3%, 0.5%, or ranges including and/or spanning the aforementioned values. In some embodiments, the pH adjusting agent (e.g., acidulant) also has chelating effects as well as buffering properties (helps to maintain pH). In some embodiments, the fire suppression and/or suppressing extinguishing composition lacks a pH adjusting agent.

While several embodiments described herein comprise a pH adjusting agent, in some embodiments, the fire suppression and/or extinguishing composition lacks a pH adjusting agent, including one or more of the pH adjusting agents disclosed elsewhere herein.

In some embodiments, the fire suppressing and/or extinguishing composition further comprises one or more foaming agents (e.g., an agent or agents that give the composition foaming properties and/or boost the foaming properties of the composition). In some embodiments, the foaming agent comprises one or more of alfalfa extract, Medicago sativa, hydroxypropyl methylcellulose (HPMC), methylcellulose, non-ionic water-soluble polymers, ionic water-soluble polymers or the like. In some embodiments, the foaming agent has antibacterial and foaming properties. In some embodiments, in addition or instead of being used as a foaming enhancer, HPMC can be used as a non-ionic water-soluble polymer that has thickening properties. In some embodiments, the weight percent of the foaming agent or foaming agents in the fire suppressing and/or extinguishing concentrate, individually or collectively, is equal to or at least about: 0.2%, 1%, 5%, 10%, 15%, or ranges including and/or spanning the aforementioned values. In some embodiments, the weight percent of the foaming agent or the foaming agents in the diluted fire suppression and/or extinguishing concentrate, individually or collectively, is equal to or less than about: 0.02%, 0.1%, 0.5%, 1.0%, 1.5%, or ranges including and/or spanning the aforementioned values. In some embodiments, the fire suppressing and/or extinguishing composition lacks a foaming agent.

In some embodiments, the fire suppressing and/or extinguishing composition further comprises one or more foam stabilizers. In some embodiments, the foaming agents acts as foam stabilizer. In some embodiments, the weight percent of the foam stabilizer(s) in the concentrated fire suppressing and/or extinguishing composition, individually or collectively, is equal to or at least about: 1%, 5%, 10%, 15%, or ranges including and/or spanning the aforementioned values. In some embodiments, the weight percent of the foam stabilizer(s) in the diluted fire suppressing and/or extinguishing composition, individually, or collectively, is equal to or at least about: 0.1%, 0.5%, 1.0%, 1.5%, or ranges including and/or spanning the aforementioned values. In some embodiments, the weight percent of the foam stabilizer(s) in the diluted fire suppressing and/or extinguishing concentrate, individually or collectively, is equal to or less than about: 0.1%, 0.5%, 1.0%, 1.5% or ranges including and/or spanning the aforementioned values. In some embodiments, the fire suppressing and/or extinguishing composition lacks a foam stabilizer, including any or more of the foam stabilizers disclosed herein. In some embodiments, the foam stabilizer comprises one or more of EDTA (ethylenediaminetetraacetic acid salt) or sodium gluconate.

In some embodiments, the fire suppressing and/or extinguishing composition further comprises one or more emulsifying agents. In some embodiments, the emulsifying agent comprises one or more of ceteareth 20, non-ionic polyoxyethylene ether of higher saturated fatty alcohols (e.g., cetyl/stearyl alcohol), or the like. In some embodiments, the emulsifying agent is one that dissolves in water and/or alcohol to form a colloid solution. In some embodiments, the emulsifying agent can be mixed with mineral, vegetable or synthetic fats and oils. In some embodiments, the emulsifying agent has an HLB (Hydrophile-Lipophile-Balance) value of about 15-17 (gives oil in water emulsions). In some embodiments, the weight percent of the emulsifying agent or emulsifying agents in the concentrated fire suppression and/or extinguishing composition (e.g., the concentrate), individually or collectively, is equal to or at least about: 0.5%, 1%, 5%, 10%, 15%, 30%, or ranges including and/or spanning the aforementioned values. In some embodiments, the weight percent of the emulsifying agent or emulsifying agents in the concentrate fire suppressing and/or extinguishing composition (e.g., the concentrate), individually or collectively, is equal to or less than about: 0.5%, 1%, 5%, 10%, 15%, 30%, or ranges including and/or spanning the aforementioned values. In some embodiments, the weight percent of the emulsifying agent or emulsifying agents in the diluted fire suppressing and/or extinguishing concentrate, individually or collectively, is equal to or at least about: 0.05%, 0.1%, 0.5%, 1.0%, 3.0% or ranges including and/or spanning the aforementioned values. In some embodiments, the fire suppressing and/or extinguishing composition lacks an emulsifying agent, including lacking any one or more of the emulsifying agents disclosed herein.

In some embodiments, the fire suppressing and/or extinguishing composition further comprises one or more chelating agents. In some embodiments, the chelating agent comprises one or more of ethylenediaminetetraacetic acid salt (“EDTA”), sodium gluconate, or the like. In some embodiments, EDTA is used as a chelating agent. In some embodiments, EDTA is used as a co-preservative. In some embodiments, EDTA is used as an emulsifier. In some embodiments, EDTA is used as a foam stabilizer. In some embodiments, the weight percent of the chelating agent or chelating agents in the concentrated fire suppressing and/or extinguishing composition, individually or collectively, is equal to or at least about: 0.1%, 1%, 5%, or ranges including and/or spanning the aforementioned values. In some embodiments, the weight percent of the chelating agent or chelating agents in the concentrated fire suppressing and/or extinguishing composition, individually or collectively, is equal to or less than about: 0.1%, 1%, 5%, or ranges including and/or spanning the aforementioned values. In some embodiments, the weight percent of the chelating agent or chelating agents in the diluted fire suppressing and/or extinguishing concentrate, individually or collectively, is equal to or less than about: 0.01%, 0.1%, 0.5%, or ranges including and/or spanning the aforementioned values. In some embodiments, the weight percent of the chelating agent or chelating agents in the diluted fire suppressing and/or extinguishing concentrate, individually or collectively, is equal to or less than about: 0.01%, 0.1%, 0.5%, or ranges including and/or spanning the aforementioned values. In some embodiments, the fire suppressing and/or extinguishing composition lacks a chelating agent, including lacking one or more of the chelating agents disclosed herein.

In some embodiments, the fire suppressing and/or fire extinguishing composition further comprises one or more preservatives. In some embodiments, the preservative comprises one or more of sodium phenoxyethanol, phenoxyethanol, caprylyl glycol, and/or sorbic acid as a preservative. In some embodiments, the weight percent of the preservative or preservatives in the concentrated fire suppressing and/or extinguishing composition (e.g., the concentrate), individually or collectively, is equal to or at least about: 0.5%, 1%, 2%, 4%, 10%, or ranges including and/or spanning the aforementioned values. In some embodiments, the weight percent of the preservative or preservatives in the concentrated fire suppressing and/or extinguishing composition (e.g., the concentrate), individually or collectively, is equal to or less than about: 0.5%, 1%, 2%, 4%, 10%, or ranges including and/or spanning the aforementioned values. In some embodiments, the weight percent of the preservative or preservatives in the diluted fire suppressing and/or extinguishing concentrate, individually or collectively, is equal to or at least about: 0.005%, 0.05%, 0.1%, 0.2%, 0.4%, 1.0%, 1.5%, 2.0%, or ranges including and/or spanning the aforementioned values. In some embodiments, the weight percent of the preservatives or preservatives in the diluted fire suppressing and/or extinguishing concentrate, individually or collectively, is equal to or less than about: 0.005%, 0.05%, 0.1%, 0.2%, 0.4%, 1.0%, 1.5%, 2.0%, or ranges including and/or spanning the aforementioned values. In some embodiments, preservatives (e.g., phenoxyethanol) provide effective broad spectrum protection against gram positive and negative bacteria, yeast, and mold while imparting emolliency to the formulation. Caprylyl glycol is a mild humectant that improves the efficacy of preservatives. In some embodiments, caprylyl glycol is used with phenoxyethanol at 1-2 weight percent of the concentrated formulation together. In some embodiments, the fire suppressing and/or extinguishing composition lacks a preservative, including lacking any one or more of the preservatives disclosed herein.

In some embodiments, additional extracts are added to the fire suppressing and/or extinguishing composition to improve its compatibility with users (e.g., to further protect or condition the skin of the user, etc.). In some embodiments, the composition comprises bamboo extract, algae extract (Laminaria), Quandong (Santalum acuminatum), Desert Lime (Citrus glauca), wattle seed (Acacia victoriae) extract, and/or cactus extract. In some embodiments, the weight percent of the additional extract(s) in the concentrated fire suppressing and/or extinguishing composition (e.g., the concentrate), individually or collectively, is equal to or at least about: 0.5%, 1%, 2%, 5%, 10%, or ranges including and/or spanning the aforementioned values. In some embodiments, the weight percent of the additional extract(s) in the diluted fire suppressing and/or extinguishing concentrate, individually or collectively, is equal to or at least about: 0.05%, 0.1%, 0.2%, 0.5%, 1.0%, or ranges including and/or spanning the aforementioned values. In some embodiments, the fire suppressing and/or extinguishing composition lacks additional extracts.

In some embodiments, psicose is used as an additive. Psicose (e.g. allulose; ribo-2-hexulose, i.e. C₆H₁₂O₆) is a low-energy monosaccharide sugar present in small quantities in natural products. In some embodiments, the weight percent of the psicose in the concentrated fire suppressing and/or extinguishing composition (e.g., the concentrate), individually or collectively, is equal to or at least about: 0.5%, 1%, 2%, 4%, 10%, or ranges including and/or spanning the aforementioned values.

In some embodiments, the concentrate comprises deionized water. In some embodiments, the water is added as a diluting agent to the fire suppressing and/or extinguishing composition to prepare the concentrate. In some embodiments, the fire suppressing and/or extinguishing composition (e.g., the concentrate) comprises water at a weight percent equal to or less than about: 10%, 15%, 20%, 25%, 30%, 35%, 40%, 50%, 60%, 65%, 70%, 80%, 85%, 90%, 98%, or ranges including and/or spanning the aforementioned values. In some embodiments, the fire suppressing and/or extinguishing composition (e.g., the concentrate) comprises water at a weight percent equal to or at least about: 10%, 20%, 40%, 60%, 70%, 80%, 90%, 98%, or ranges including and/or spanning the aforementioned values. In some embodiments, the fire suppressing and/or extinguishing concentrate is diluted with deionized water. Deionized water is non-conductive and can be used with the composition to extinguish Class C fires with a unique mist spray nozzle. When discharged, the diluted composition releases micro-droplets, creating intense cooling to the fire and suffocating the fire by depleting the oxygen.

In some embodiments, the concentrated fire suppressing and/or extinguishing (e.g., the concentrate) is diluted with additional water to prepare a dilute composition. In some embodiments, the concentrated fire suppressing and/or extinguishing (e.g., the concentrate) is diluted to a weight percent (wt %) of equal or less than about: 0.25%, 3%, 6%, 10%, 20%, 40%, 60%, 80%, 90%, 98%, or ranges including the aforementioned values. For instance, for a 10 wt % solution of the fire suppressing and/or extinguishing composition can be prepared by diluting 100 g of the concentrated fire suppressing and/or extinguishing composition (e.g., the concentrate) with 900 g of water.

In some embodiments, the concentrated fire suppressing and/or extinguishing composition is diluted with water to a volume percent (vol %) of equal to or less than about: 0.25%, 1%, 3%, 5%, 6%, 9%, 10%, 20%, 40%, 60%, 80%, 90%, 98%, or ranges including and/or spanning of the aforementioned values. For instance, for a 10 vol % solution of the fire suppressing and/or extinguishing composition can be prepared by diluting 1 quart of the concentrated fire suppressing and/or extinguishing composition (e.g., the concentrate) with 9 quarts of water.

In some embodiments, the concentrated fire suppressing and/or extinguishing composition is diluted with water to a weight volume (or w/v) of equal to or less than about: 2%, 10%, 20%, 40%, 60%, 80%, 90%, 98%, or ranges including and/or spanning the aforementioned values. For instance, for a 10% w/v solution of the composition can be prepared by diluting 10 g of the concentrated fire suppressing and/or extinguishing composition (e.g., the concentrate) to a volume of 100 mL using water. In some embodiments, the concentrated fire suppressing and/or extinguishing composition is used without dilution.

For brevity, only certain exemplary wt % values for each possible ingredient in the diluted formulations have been provided above. However, in view of the dilution levels disclosed above, the wt %, vol %, and % w/v value for each particular ingredient in a diluted formulation (from concentrate as disclosed elsewhere herein). In other words, it should be appreciated that the total concentration of each ingredient disclosed elsewhere herein can be expressed as a proportion of the diluted formulation. For example, where a concentrate is disclosed as comprising 50 wt % of botanical material, and where a concentrate is disclosed being dilutable at 10 wt % solution with water, while not expressly written, a diluted formulation comprising botanical material at 5 wt % is also disclosed. The following paragraph also illustrates the concept of dilution contemplated herein.

For instance, 100 g of concentrate can be prepared by adding 50 g of botanical material to 50 g of other ingredients (e.g., a thickening agent, a surfactant, a humectant, an antifreeze agent, a pH adjusting agent, etc.). This concentrate is 50 wt % botanical material. If that concentrate is then diluted with 900 g of water, the wt % of the botanical material is 5 wt % of the diluted formulation. Similarly, where that same 100 g of concentrate is diluted with 1900 g of water, the wt % of the botanical material is 2.5% wt % of the diluted formulation. The wt % of the botanical materials to the diluted solution may be expressed in terms of a weight ratio. For instance, in the first example above, the ratio of diluted solution to botanical material is 20:1. Also, in the second example, the weight ratio is 40:1. In some embodiments, the weight ratio is equal to or about: 1:1, 2:1, 3:1, 4:1, 5:1, 6:1, 7:1, 8:1, 9:1, 10:1, 15:1, 20:1, 25:1, 30:1, 40:1, 50:1, or ranges including and/or spanning the aforementioned values.

Without being bound to any mechanism, it is believed that the fire suppressing and/or extinguishing composition acts, at least in part, as water delivery agent and/or that evaporating cooling aids in the cooling of the fire. In some embodiments, prior to deploying the composition, it is diluted with water.

As discussed elsewhere herein, some embodiments of the fire suppressing and/or extinguishing composition disclosed herein are not toxic. In some embodiments, small quantities (e.g., less than 5 g, 10 g, 50 g, 100 g) can be ingested safely (e.g., by a human, mammal, or other animal). In some embodiments, the fire suppressing and/or extinguishing compositions disclosed herein can be applied to the skin of humans or other mammals and animals (e.g., dogs, cats, livestock, birds, reptiles, fish, etc.) safely and/or substantially without reaction (e.g., a skin reaction such as a rash or burn). In some embodiments, applications of at least 5 g of the composition to the skin (e.g., by rubbing a person's arm with the composition) leaves no lasting or visible residue on the skin after less than or equal to (about: 5 minutes, 15 minutes, 30 minutes, or ranges including and/or spanning the aforementioned values. In some embodiments, the fire suppressing and/or extinguishing composition is environmentally friendly. In some embodiments, the fire suppressing and/or extinguishing composition is biodegradable and does not substantially harm the environment. In some embodiments, the fire suppressing and/or extinguishing composition is composed primarily or substantially completely of naturally occurring ingredients (e.g., those found in nature).

In some embodiments, the fire suppressing and/or extinguishing composition is halogen-free. In some embodiments, the fire suppressing and/or extinguishing composition lacks compounds having halogen atoms. In some embodiments, the fire suppressing and/or extinguishing composition lacks compounds having −F, −Cl, −Br, and/or −I. In some embodiments, the fire suppressing and/or extinguishing composition is free of sugar alcohols. In some embodiments, the fire suppressing and/or extinguishing composition lacks dulcitol, iditol, mannitol, erythritol, threitol, arabitol, ribitol, sorbitol, and/or xylitol. In some embodiments, the fire suppressing and/or extinguishing composition lacks and/or is free of halogen containing ingredients. In some embodiments, the fire suppressing and/or extinguishing composition lacks and/or is free of sugar alcohols.

In some embodiments, the fire suppressing and/or extinguishing composition has a heat capacity that is higher than the heat capacity of water (e.g., 4.184 Joules/g/K). In some embodiments, the heat capacity of the fire suppressing and/or extinguishing composition is at least 5 Joules/g/K, 8 Joules/g/K, 11 Joules/g/K, 14 Joules/g/K, or ranges including and/or spanning the aforementioned values.

In some embodiments, the fire suppressing and/or extinguishing composition has a rapid cooling effect, lowering the temperature of the burning material below its flashpoint. In some embodiments, the fire suppressing and/or extinguishing composition also rapidly cools the material that was burning after the fire is extinguished. In some embodiments, the temperature of the material after the fire has been put out is decreased to a temperature at or below room temperature (e.g. about 73° F.). In some embodiments, application of the fire suppressing and/or extinguishing composition extinguishes fire fueled by a flaming object and simultaneously, cools the object after the fire is extinguished to a temperature below about 300° F., 200° F., 100° F., 72° F., or ranges including and/or spanning the aforementioned values. In some embodiments, the temperature of the object is decreased to below 100° F. within a time after the fire is extinguished of about: 1 s, 5 s, 10 s, 30 s, or ranges including and/or spanning the aforementioned values. In some embodiments, the temperature of the extinguished material (e.g., magnesium metal) decreases to below room temperature (e.g. about 72° F.) at a time after the fire is extinguished of about: 1 s, 5 s, 10 s, 30 s, or ranges including and/or spanning the aforementioned values.

Some embodiments pertain to methods of preparing the fire suppressing and/or extinguishing composition. In some embodiments, a temperature suppressing agent and/or water delivery agent is mixed with stirring. In some embodiments, where the temperature suppressing agent and/or water delivery agent is in powder form, it is mixed in a sufficient quantity of water, as described elsewhere herein, to dissolve the water or suspend the powder. In some embodiments, a thickening agent is added while mixing. In some embodiments, a surfactant is added while mixing. In some embodiments, a humectant is added while mixing. In some embodiments, an agent that prevents the crystallization of water (e.g., an antifreeze agent) is added while mixing. In some embodiments, a pH adjusting agent is added while mixing. In some embodiments, the composition is diluted with water, as described elsewhere herein.

In some embodiments, the formulation is placed in a canister (e.g., a fire extinguisher) for deployment as a concentrate or diluted formulation. In some embodiments, the container (e.g., canister) is pressurized using a compressed gas (e.g., air, CO₂, N₂, etc.). In some embodiments, the composition deploys as a mist, spray, liquid, gel or aerogel. In some embodiments, the fire suppressing and/or extinguishing composition is placed within a fire extinguisher canister. In some embodiments, the canister is pressurized to a pressure of equal to or at least about 80 psi, 100 psi, 120 psi, 150 psi, or ranges including and/or spanning the aforementioned values. For example, in some embodiments, using a 2.5 gallons extinguisher about 1 quart of fire suppressing and/or extinguishing composition is added. In some embodiments, about 9 quarts of water (e.g., tap water, distilled water and/or deionized water) is then added. In some embodiments, the dilution is performed in the canister. In some embodiments, the fire extinguisher is then sealed and pressurized to about 120 psi using, for example, a compressor.

In some embodiments, the concentrate can be distributed as a foam using a proportioner (e.g., FoamPro or similar proportioners). Proportioners can be attached to fire hoses and/or fire extinguishers to distribute a concentrate into a flowing liquid stream (e.g., water), diluting the concentrate to a desired level. In some embodiments, the proportioner dilutes the composition concentrate by vol %. In some embodiments, the proportioner dilutes the composition concentrate by a vol %. In some embodiments, the proportioner dilutes the concentrated fire suppressing and/or extinguishing composition to a volume percent (vol %) of equal to or less than about: 0.25%, 1%, 3%, 5%, 6%, 9%, 10%, 20%, 40%, 69%, 80%, 90%, 98%, or ranges including and/or spanning the aforementioned values. In some embodiments, the formulation is miscible with water. In some embodiments, the composition stays miscible in water when deployed by a proportioner into a stream of water. In some embodiments, the polymeric components of the composition are mutually miscible. In some embodiments, the polymeric components of the composition remain mutually miscible when deployed by a proportioner.

In some embodiments, the proportioner discharges the concentrate into a discharge side of the nozzle. By injecting into the discharged side, proportioning performance is not affected by external factors such as nozzle, length of hose lay, nozzle elevation or incoming pressure to water pump. In some embodiments, the proportioning system automatically reads water flow and injects concentrate: from 0.1% to 10.0%.

In some embodiments, a polymeric temperature suppressing agent and/or water delivery agent (e.g., botanical material) and polymeric thickening agent (e.g., polysaccharide) are mutually miscible. Mutual miscibility beneficially provides an extinguishing agent that is distributed uniformly and reproducibly when used. In some embodiments, the temperature suppressing agent and/or water delivery agent (e.g., botanical material) and the thickening agent (e.g., polysaccharide) are mutually miscible in the composition at a concentration of at least about 0.25% and at least about 0.25% respectively. In some embodiments, the temperature suppressing agent and/or water delivery agent and the thickening agent are mutually miscible in the composition at a concentration of at least about 0.1% and at least 0.1% respectively.

Some embodiments pertain to methods of suppressing and/or extinguishing fires. In some embodiments, the method involves contacting a fire fuel source (e.g., a Class A, B, C, D, K fire sources) with a fire suppressing and/or extinguishing composition as described elsewhere herein. In some embodiments, the method for suppressing and/or extinguishing the fire includes a step of applying a fire suppressing and/or extinguishing composition to an object or person at risk of catching fire (e.g., to extinguish the fire). For example, in some embodiments, the composition can be applied to the skin, the clothing (e.g., the uniform of a firefighter, military personnel, police, etc.), fabrics (e.g., burlap, cotton cloth, synthetic fabrics, etc.), fur, a vehicle (e.g., tires, exterior surfaces, interior surfaces, etc.), buildings (e.g., a roof, exterior surfaces, interior surfaces, etc.), or raw materials for fabricating any of the foregoing (e.g., magnesium wheel frames, wood piles, textiles, cloth, etc.), wherein the composition is applied prior to exposure to an ignition source or fire, or while the burning article is on fire.

In some embodiments, the fire suppressing and/or extinguishing composition is effective in extinguishing or suppressing fire events likely to be encountered during military operations. In some embodiments, the fire suppressing and/or extinguishing composition is effective for used across fire classes. In some embodiments, the fire suppressing and/or extinguishing is organic-halide free (e.g., fluorocarbon-free and/or halon-free). In some embodiments, the fire suppressing and/or extinguishing composition is sugar-alcohol free. In some embodiments, the fire suppressing and/or extinguishing composition is composed of natural-products and/or is safe to the environment and to mammals and/or animals (e.g., humans, dogs, cats, livestock, birds, reptiles, fish, etc.). In some embodiments, the fire suppressing and/or extinguishing composition is safe to deploy around or on humans. In some embodiments, upon being deployed, the fire suppressing and/or extinguishing composition can be inhaled without damage and/or without substantial damage to the lungs. In some embodiments, the fire suppressing and/or extinguishing composition deploys without requiring the explosive forces typical of those used to deploy fluorocarbon and halon-based compositions. In some embodiments, the fire suppressing and/or extinguishing composition is safe to ingest. In some embodiments, the fire suppressing and/or extinguishing composition remains in an aqueous state as it is being deployed from its storage means in response to a fire event. In some embodiments, the fire suppressing and/or extinguishing composition does not produce any acid gases when exposed to the high heat and temperatures associated with fire events.

In some embodiments, the fire suppressing and/or extinguishing composition instantaneously or substantially instantaneously deploys from a storage means (e.g., a container) typically used in fire suppression systems, including but not limited to fire extinguishers, extinguishers, backpacks, holding tanks, and building and vehicle fire suppression piping systems, without the need for the high forces required by fluorocarbon and halon-based compositions. In some embodiments, the fire suppressing and/or extinguishing composition can be stored for relatively long periods of time and in a wide range of temperatures conditions yet retain fire suppression characteristics and remain in an immediately deployable state.

One or more embodiments of the composition is non-fluorinated with low viscosity, superior expansion rate and a very high drainage time. Several foam formulations were tested for expansion, drainage and separation in both clean and salt water. For separation, an overnight wait and observation was required. These compositions exclude all PFOS and PFAS compounds.

### Exemplary Formulations

In the following formulations, xanthan gum was selected as a polymeric material because of its ability as a polysaccharide to be water soluble and swellable. It has very good synergy with the active ingredient found in Aloe Vera (i.e. acemannan), is thermally stable, resistant to pH change, and high salt content (sea water for example). The xanthan gum aids in causing the foam to form a gelatin when it comes in contact with a polar hydrophilic liquid (alcohols, ketones, etc.). Therefore, it acts as a barrier towards the fuel vapors and liquids, binds with the surfactant and prevents the foam blanket from breaking.

Each of the following formulations, and derivatives thereof, had to be tested for expansion and drainage in both salt and clean water every single time.

One of the many formulations tested on all classes of fire, and specifically on Class B fire, is presented in the table below.

| Sample | Ingredients | ~Wt (Oz) | ~Wt % |
|---|---|---|---|
| HEF-1 | Aloe Vera powder | 0.064 | 0.05 |
| | Xanthan Gum | 5.0 | 3.91 |
| | Decyl Glucoside | 33.52 | 26.19 |
| | 1,3-Propanediol | 22.35 | 17.46 |
| | 40% solution of Sodium C14-16 Alpha | 44.69 | 34.92 |
| | Olefin Sulfonate (“AOS 40”) | | |
| | Coco Glucoside | 22.35 | 17.46 |
| | Citric Acid as needed for pH adjustment | | |

The HEF-1 formulation was used for testing at 3% dilution (e.g. with water). The tests were performed for various fuels, e.g. diesel, alcohol, acetone, mineral oil, etc., in a big aluminum cooking pan. For each test, the fuel is left to burn for about one minute before the foam is applied. The fuel tube is kept inside the pan to recreate the self-healing action of the fuel and for possible re-ignition (i.e. try to anyway).

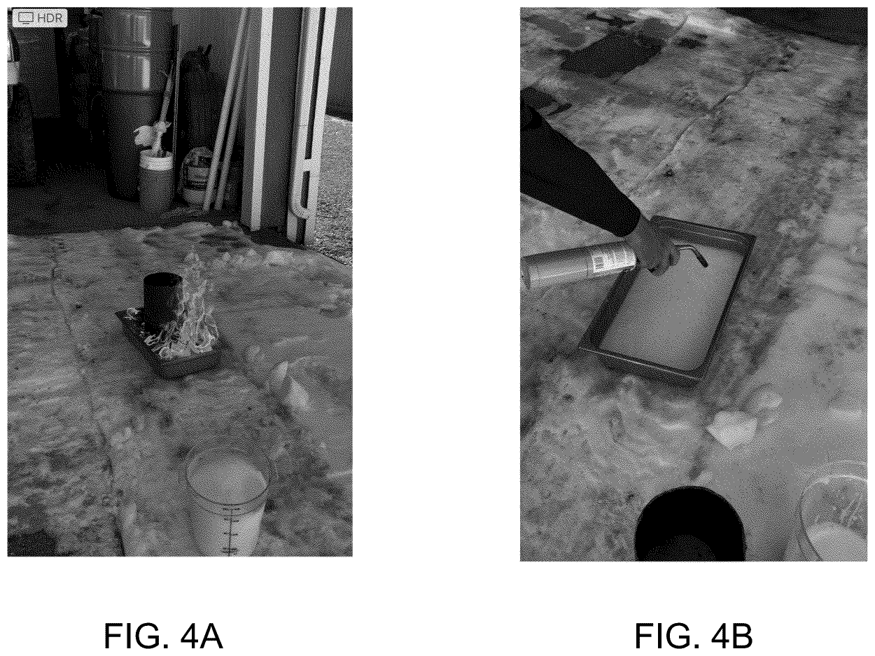

For such small-scale fires, it takes less than 5 seconds to extinguish the fire with the diluted foam composition. Observations include complete encapsulation of the fuel; the liquid is cold to the touch; and it won't reignite no matter how much effort to try to break up the foam blanket. Observations in 15 minutes intervals reveal that the foam remained thick with no reignition after more than an hour. The results are shown in FIG. 4A and FIG. 4B.

The gum and the type of surfactants are critical to the success of the composition. The goal is to create a thick foam with lots of body without getting too high viscosity. Because high viscosity means difficulty in pumping of the diluted composition onto the fire. The viscosity for HEF-1 was about 194 cP.

The composition is discharged at 3% dilution out of a fire extinguisher and it does really good with a very good vertical adherence which is needed for airplanes and military vehicles.

The next composition, HEF-2 presented in table below, tested was formulated without coco glucoside, and decyl glucoside. With HEF-2, the drain test produced an equivalent result as HEF-1, at about 48 minutes with clean water; and in salt water, the drain time was about 56 minutes with a very heavy foam.

The test was performed with an ANSUL system which consists of a big fan attached to a net. The composition is diluted by induction at 3% attached to a 1- and ¾-inch hose at 90 psi water pressure.

The foam was absolutely fantastic with a rapid travel and excellent coverage. It would fill up a hangar in case of a fire very quickly and efficiently. The foam was long lasting.

| Sample | Ingredients | ~Wt (Oz) | ~Wt % |
|---|---|---|---|
| HEF-2 | Deionized Water | 6.0 | 15.54 |
| | Aloe Vera powder | 0.0115 | 0.03 |
| | Xanthan Gum | 0.6 | 1.55 |
| | Coco Betaine | 18.0 | 46.62 |
| | 1,3-Propanediol | 10.0 | 25.90 |
| | AOS 40 | 4.0 | 10.36 |
| | TEA for pH adjustment | | |

Formulation of composition HEF-2 required first mixing the two surfactants together first (Coco Betaine and AOS 40) which creates a paste because of the AOS 40. The water (e.g. de-ionized water) is then added and the mixture hydrates while mixing slowly.

The xanthan gum and aloe vera powder are externally mixed with half of the propanediol before adding to the surfactant mixture. Finally, the remaining half of the propanediol is added to the mixture and the composition is further mixed.

In some embodiments, the composition comprises a vegetable glycerin.

Ethanol (a class B fire agent) was then tested. Briefly, 2 quarts of ethanol was placed in a metal container and lit on fire with a torch. The fire was allowed to burn until reaching over 2000° F. At about a 45° angle, the formulation was then sprayed at the base of the fire. The formulation extinguished the fire in less than 3 seconds with a temperature dropping from over 2000° F. to about 49° F. in less than 10 seconds. It was noted that the oil on the top of the solution was encapsulated. No matter how much it was attempted, the ethanol would not reignite, and it could be touched with bare hands (bare fingers could be submerged in the ethanol). Ethanol is very hard to extinguish due to its high volatility (showing the high efficacy of the formulation). Tests were also performed on 2 quarts of Isopropyl Alcohol as well as 2 quarts of dimethyl ketone.

Upon discharged from the fire extinguisher, the compound produced stable foam with a very slow drainage. Without being bound to a mechanism, it is believed that the foam blankets the fuel surface smothering the fire, separating the flames and ignition source from the fuel surface by encapsulation. It is also believed that the formulation cools the fuel and suppresses the release of flammable vapors that can mix with the air. It was noted that the formulation had high thermal resistance, with a very good viscosity. It was noted that competitor products showed breakage and very poor stability of foam, yet the bubbles created with the disclosed formulation were very strong and the foam had a very slow drainage. It is noted that the foam viscosity doesn't seem to decrease with the foam temperature. When heated by the radiation of the fire, the foam doesn't seem to flow any faster than a cold foam. The formulation had no slippery feeling and provided a good seal against fuel vapors.

The next series of compositions, HEF-3, HEF-4, and HEF-5 all demonstrated excellent results during test. These compositions comprise adding cationic ingredients to the anionic surfactants and balancing the concentration of the surfactants.

| Sample | Ingredients | ~Wt (Oz) | ~Wt % |
|---|---|---|---|
| HEF-3 | Deionized Water | 31.69 | 24.76 |
| | Aloe Vera powder | 0.11 | 0.086 |
| | Xanthan Gum | 0.7 | 0.55 |
| | Cationic Xanthan Gum | 0.23 | 0.18 |
| | Guar Hydroxypropyltrimonium chloride | 0.27 | 0.21 |
| | Galactoarabinan | 0.5 | 0.39 |
| | Coco Betaine | 42.26 | 33.02 |
| | 1,3-Propanediol | 17.58 | 13.73 |
| | 1,2-propylene glycol | 12.31 | 9.62 |
| | AOS 40 | 2.87 | 2.24 |
| | 70% solution of Sodium Laureth Sulfate | 10.87 | 8.49 |
| | (“SLES 70”) | | |
| | Sulfoccinate | 2.34 | 1.83 |
| | Polyglucose | 2.79 | 2.18 |
| | Glycine Betaine | 3.17 | 2.48 |
| | Phenoxyethanol | 0.31 | 0.24 |

| Sample | Ingredients | ~Wt (Oz) | ~Wt % |
|---|---|---|---|
| HEF-4 | Deionized Water | 31.69 | 24.91 |
| | Aloe Vera powder | 0.11 | 0.09 |
| | Xanthan Gum | 0.7 | 0.55 |
| | Cationic Xanthan Gum | 0.23 | 0.18 |
| | Coco Betaine | 42.26 | 33.22 |
| | 1,3-Propanediol | 17.58 | 13.82 |
| | 1,2-propylene glycol | 12.31 | 9.68 |
| | AOS 40 | 2.87 | 2.26 |
| | 70% solution of Sodium Laureth Sulfate | 10.87 | 8.54 |
| | (“SLES 70”) | | |
| | Sulfoccinate | 2.34 | 1.84 |
| | Polyglucose | 2.79 | 2.19 |
| | Glycine Betaine | 3.17 | 2.49 |
| | Phenoxyethanol | 0.31 | 0.24 |

| Sample | Ingredients | ~Wt (Oz) | ~Wt % |
|---|---|---|---|
| HEF-5 | Deionized Water | 31.69 | 26.13 |
| | Aloe Vera powder | 0.11 | 0.09 |
| | Xanthan Gum | 0.7 | 0.58 |
| | Cationic Xanthan Gum | 0.23 | 0.19 |
| | Coco Betaine | 42.26 | 34.85 |
| | 1,3-Propanediol | 17.58 | 14.50 |
| | 1,2-propylene glycol | 12.31 | 10.15 |
| | AOS 40 | 2.87 | 2.37 |
| | 70% solution of Sodium Laureth Sulfate | 10.87 | 8.96 |
| | (“SLES 70”) | | |
| | Glycine Betaine | 3.17 | 1.93 |
| | Phenoxyethanol | 0.31 | 0.26 |

The HEF-3 composition passed all of the UL (Underwriters Laboratory) requirements, as far as expansion, and drain time and is the only formula with the best viscosity/performance properties available. The expansion ratio for the HEF3-5 formulations is equivalent to HEF-1, i.e. about 7, and the drainage time is equivalent to the times demonstrated on with the HEF-2 tests. The viscosity is about 194 cP.

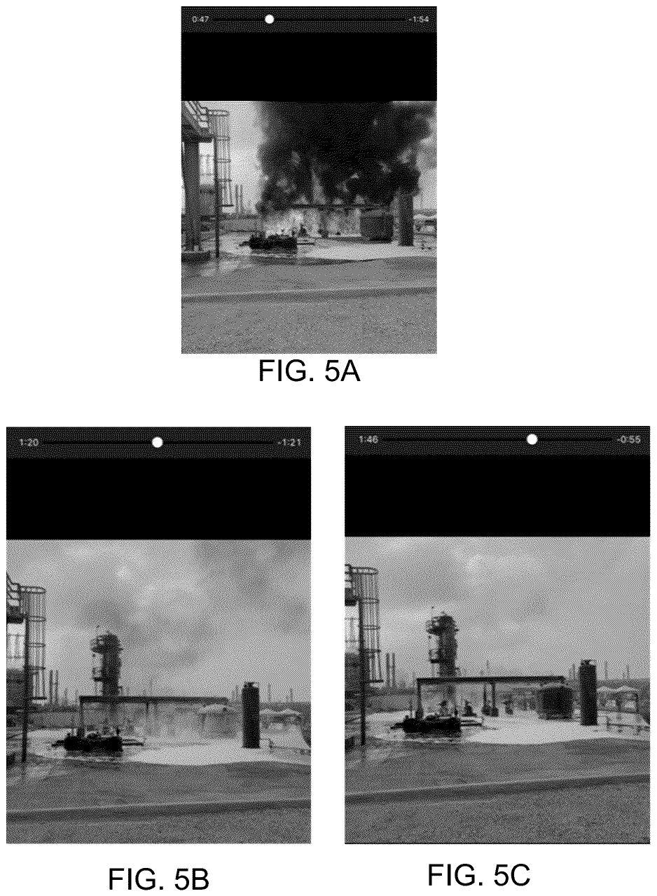

The tests were performed at 3% concentration, which is a direct replacement for AFFF. The results of the HEF-3 composition tests on a full-blown 1000 square ft gasoline plus methane mixture fire at a petroleum plant are shown in FIGS. 5A-C. As presented, a full-blown Class B fire (FIG. 5A) was substantially extinguished in about 30 seconds (FIG. 5B), and finally extinguished in less than 60 seconds (FIG. 5C). The fire chief for a mutual aid fire fighting force for some major oil companies commented that it was the best product he'd ever seen in his career.

In one or more embodiments, the composition concentrate comprises deionized water. In some embodiments, the water is added as a diluting agent to the fire suppressing and/or extinguishing composition to prepare the concentrate.

In one or more of the embodiments, the composition concentrate comprises one or more polysaccharides such as aloe vera extract, xanthan gum, other similar polysaccharides and their derivatives, etc.

In one or more of the embodiments, the composition concentrate comprises one or more thickening agents such as galactoarabinan and guar hydroxypropyltrimonium chloride.

In one or more of the embodiments, the composition concentrate comprises one or more non-ionic and anionic surfactants such as coco betaine, decyl glucoside (or polyglucose), coco glucoside, sodium C14-16 alpha olefin sulfonate, sodium laureth sulfate, cocamidopropylamine oxide, sulfoccinate, glycine betaine, other similar surfactants and their derivatives etc.

In one or more of the embodiments, the composition concentrate comprises one or more humectants such as 1,3-Propanediol and 1,2-propylene glycol.

In one or more of the embodiments, the composition concentrate comprises one or more cationic ingredients such as cationic xanthan gum, guar hydroxypropyltrimonium chloride, and other cationic ingredients, including cationic surfactants.

In one or more of the embodiments, the composition concentrate further comprises one or more of a preservative, e.g. phenoxyethanol.

In one or more of the embodiments, the composition concentrate further comprises one or more pH adjusting agent such as citric acid, and TEA.

As illustrated in formulations HEF-4 and HEF-5, disclosed herein, the galactoarabinan as well as the guar hydroxypropyltrimonium chloride can be eliminated and still provide excellent fire extinguishing foam characteristics that meets or exceeds UL requirements. The galactoarabinan and guar hydroxypropyltrimonium chloride increases the viscosity of the formulation, which is still acceptable; however, lower viscosity is preferable.

In one or more embodiments, the sulfoccinate and polyglucose may be substituted by upping the coco betaine and the SLES.

In one or more embodiments, the glycine betaine, which acts as a foam enhancer and stabilizer, is maintained at about 10% of my water content.

One or more embodiments, comprise SLES and/or cocamidopropylamine oxide to help stabilize the foam generated by the coco betaine and AOS.

In summary, various embodiments and examples of fire extinguishing and/or suppressing compositions, systems and devices related thereto, and their methods of manufacture and use has been disclosed. Although the compositions have been disclosed in the context of various embodiments and examples, it will be understood by those skilled in the art that this disclosure extends beyond the specifically disclosed embodiments, as well as to certain modifications and equivalents thereof. This disclosure expressly contemplates that various features and aspects of the disclosed embodiments can be combined with or substituted for one another. Accordingly, the scope of this disclosure should not be limited by the particular disclosed embodiments described above but should be determined only by a fair reading of the claims that follow.

1. A fire suppressing composition concentrate comprising:
deionized water in an amount between 20% and 30% by weight;
aloe vera powder in an amount between 0.05% and 0.15% by weight;
xanthan gum in an amount between 0.2% and 1.0% by weight;
cationic xanthan gum in an amount between 0.1% and 0.3% by weight;
coco betaine in an amount between 20% and 40% by weight;
1,3-propanediol in an amount between 5% and 20% by weight;
1,2-propylene glycol in an amount between 5% and 20% by weight;
sodium C14-16 alpha olefin sulfonate in an amount between 0.2% and 5.0% by weight;
sodium laureth sulfate in an amount between 4.0% and 15.0% by weight; and
glycine betaine in an amount between 0.5% and 4.0% by weight.

2. The fire suppressing composition concentrate of claim 1, further comprising guar hydroxypropyltrimonium chloride in an amount between 0.1% and 0.3% by weight.

3. The fire suppressing composition concentrate of claim 2, further comprising galactoarabinan in an amount between 0.2% and 0.5% by weight.

4. The fire suppressing composition concentrate of claim 3, further comprising sulfoccinate in an amount between 0.5% and 4.0% by weight.

5. The fire suppressing composition concentrate of claim 4, further comprising polyglucose in an amount between 0.5% and 4.0% by weight.

6. The fire suppressing composition concentrate of claim 2, further comprising sulfoccinate in an amount between 0.5% and 4.0% by weight.

7. The fire suppressing composition concentrate of claim 2, further comprising polyglucose in an amount between 0.5% and 4.0% by weight.

8. The fire suppressing composition concentrate of claim 1, further comprising phenoxyethanol in an amount between 0.1% and 0.4% by weight.

9. (canceled)

10. (canceled)

11. (canceled)

12. (canceled)

13. An article of manufacture comprising:
a fire extinguisher cannister;
a fire suppressing composition concentrate in said cannister, wherein said composition concentrate comprises:
deionized water in an amount between 20% and 30% by weight;
aloe vera powder in an amount between 0.05% and 0.15% by weight;
xanthan gum in an amount between 0.2% and 1.0% by weight;
cationic xanthan gum in an amount between 0.1% and 0.3% by weight;
coco betaine in an amount between 20% and 40% by weight;
1,3-propanediol in an amount between 5% and 20% by weight;
1,2-propylene glycol in an amount between 5% and 20% by weight;
sodium C14-16 alpha olefin sulfonate in an amount between 0.2% and 5.0% by weight;
sodium laureth sulfate in an amount between 4.0% and 15.0% by weight; and
glycine betaine in an amount between 0.5% and 4.0% by weight; and
water in said canister to achieve a desired percentage dilution of said composition.

14. The article of manufacture of claim 13, wherein said composition concentrate further comprises guar hydroxypropyltrimonium chloride in an amount between 0.1% and 0.3% by weight.

15. The article of manufacture of claim 14, wherein said composition concentrate further comprises galactoarabinan in an amount between 0.2% and 0.5% by weight.

16. The article of manufacture of claim 15, wherein said composition concentrate further comprises sulfoccinate in an amount between 0.5% and 4.0% by weight.

17. The article of manufacture of claim 16, wherein said composition concentrate further comprises polyglucose in an amount between 0.5% and 4.0% by weight.

18. The article of manufacture of claim 13, wherein said composition concentrate further comprises galactoarabinan in an amount between 0.2% and 0.5% by weight.

19. The article of manufacture of claim 13, wherein said composition concentrate further comprises sulfoccinate in an amount between 0.5% and 4.0% by weight.

20. The article of manufacture of claim 13, wherein said composition concentrate further comprises polyglucose in an amount between 0.5% and 4.0% by weight.
